(19) United States
(12) Patent Application Publication
(10) Pub. No.: US 2026/0260119 A1
(43) Pub. Date: Sep. 3, 2026

(54) MULTI-LAYER FEEDFORWARD NEURAL NETWORK TRAINING METHOD AND SYSTEM FOR ISING MACHINE

(71) Applicant: TSINGHUA UNIVERSITY, Beijing (CN)

(72) Inventors: Shengbo LI, Beijing (CN); Xujie SONG, Beijing (CN); Tong LIU, Beijing (CN); Jingliang DUAN, Beijing (CN); Bo CHENG, Beijing (CN)

(21) Appl. No.: 19/655,576

(22) Filed: Apr. 22, 2026

Related U.S. Application Data
(63) Continuation of application No. PCT/CN2024/124169, filed on Oct. 11, 2024.

(30) Foreign Application Priority Data
Oct. 23, 2023 (CN) 202311379749.7
Apr. 30, 2024 (CN) 202410539239.X

(51) Int. Cl. G06N 3/09; G06N 3/0495; G06N 3/0499

(52) U.S. Cl. CPC G06N 3/09; G06N 3/0495; G06N 3/0499

(57) ABSTRACT

The present application relates to a multi-layer feedforward neural network training method and system for an Ising machine. The method comprises: modeling supervised learning of a multi-layer feedforward quantized neural network as a quadratic constrained binary optimization problem; converting the quadratic constrained binary optimization problem into a quadratic unconstrained binary optimization problem; solving the quadratic unconstrained binary optimization problem on an Ising machine to obtain an optimal solution to the quadratic unconstrained binary optimization problem; and decoding the optimal solution to obtain parameters of the trained multi-layer feedforward neural network. According to the embodiment, efficient and fast solution can be implemented on the Ising machine to train the multi-layer feedforward neural network, the scheme reduces the use of spin numbers, simplifies the difficulty of problem solution, and can solve large-scale training problems.

### TECHNICAL FIELD

The present application relates to the field of artificial intelligence and quantum computing, and in particular, to a multi-layer feedforward neural network training method and system for an Ising machine.

### BACKGROUND

At present, the huge computational overhead of training deep neural networks has become a key bottleneck in the development of artificial intelligence. The traditional gradient-based back propagation training method encounters many problems such as vanishing gradients and getting trapped in local optima, and this training method requires a large number of graphic processing units (GPU) to efficiently update the model. As a dedicated quantum computer, Ising machines have achieved a large number of spin bits, showing the potential for training neural networks on Ising machines.

So far, Ising machines have been used for some machine learning tasks, such as training of support vector machines and training of clustering models. Meanwhile, in the field of neural networks, Ising machine can be used to train Boltzmann Machine and Dynamical Energy Network, and neither of these two types of networks belongs to feedforward networks. Due to a powerful representation capability, a fast inference capability, and a flexible connection structure of a feedforward network, a multi-layer feedforward network is a neural network type most widely used in industry. The current challenge is how to efficiently and quickly solve on an Ising machine to realize the training of a multi-layer feedforward neural network.

### SUMMARY

In view of this, the present application provides a multi-layer feedforward neural network training method and system for Ising machine.

According to an aspect of the present application, a multi-layer feedforward neural network training method for an Ising machine is provided. The method comprises: modeling supervised learning of a multi-layer feedforward quantized neural network as a quadratic constrained binary optimization problem; converting the quadratic constrained binary optimization problem into a quadratic unconstrained binary optimization problem; solving the quadratic unconstrained binary optimization problem on an Ising machine to obtain an optimal solution to the quadratic unconstrained binary optimization problem; and decoding the optimal solution to obtain parameters of the trained multi-layer feedforward neural network.

In a possible implementation, the modeling supervised learning of the multi-layer feedforward quantized neural network as a quadratic constrained binary optimization problem comprises: representing an activation function in a feedforward topology of the quantized neural network as an inequality constraint, and representing a linear transformation in the feedforward topology of the quantized neural network as an equality constraint; and modeling the supervised learning of the multi-layer feedforward quantized neural network as the quadratic constrained binary optimization problem based on a loss function of the quantized neural network, the constraint condition, and an encoded optimization variable, where an objective function of the quadratic constrained binary optimization problem is the loss function of the quantized neural network. The constraint conditions comprise equality constraints and inequality constraints.

In a possible implementation, the modeling supervised learning of the multi-layer feedforward quantized neural network as a quadratic constrained binary optimization problem comprises: representing an activation function in a feedforward topology of the quantized neural network as an inequality constraint, and representing a linear transformation in the feedforward topology of the quantized neural network as an equality constraint; converting the inequality constraint into the equality constraint by using an auxiliary variable; and modeling the supervised learning of the multi-layer feedforward quantized neural network as the quadratic constrained binary optimization problem based on a loss function of the quantized neural network, the equality constraint, and an encoded optimization variable, where an objective function of the quadratic constrained binary optimization problem is the loss function of the quantized neural network.

In a possible implementation, the optimization variables comprise a quantized weight of each layer in the quantized neural network, a quantization bias of each layer, a value of each layer before activation, a value of each layer after activation, a predicted value of a sample, and an auxiliary variable.

In a possible implementation, the converting the quadratic constrained binary optimization problem into a quadratic unconstrained binary optimization problem, comprises: eliminating all equality constraints in the quadratic constrained binary optimization problem by using a penalty function method, and constructing a penalty function; and reducing the penalty function by using a Rosenberg order reduction method, and converting the quadratic constrained binary optimization problem into the quadratic unconstrained binary optimization problem.

In a possible implementation, the eliminating all equality constraints in the quadratic constrained binary optimization problem by using a penalty function method to construct a high-order loss function comprises: calculating the difference between the two ends of the equality constraints, and adding a square of the difference to the loss function as a penalty term; and introducing a penalty coefficient to the penalty term in the loss function to obtain the high-order loss function.

In a possible implementation, the reducing the high-order loss function or the augmented Lagrange function by using a Rosenberg order reduction method, and converting the quadratic constrained binary optimization problem into a quadratic unconstrained binary optimization problem comprises: determining a quadratic term factor that appears most frequently in the high-order loss function or the augmented Lagrange function, and replacing the quadratic term factor with an auxiliary binary variable; adding a Rosenberg polynomial as a penalty term to the original loss function; and iteratively performing the Rosenberg reduction method until the order of the penalty function is reduced to quadratic to obtain a quadratic loss function, converting the quadratic constrained binary optimization problem into a quadratic unconstrained binary optimization problem.

In a possible implementation, the reducing the penalty function by using a Rosenberg order reduction method, and converting the quadratic constrained binary optimization problem into the quadratic unconstrained binary optimization problem, comprises: determining a quadratic term factor that occurs most frequently in the penalty function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, and converting the quadratic constrained binary optimization problem into the quadratic unconstrained binary optimization problem.

In a possible implementation, the converting the quadratic constrained binary optimization problem into a quadratic unconstrained binary optimization problem comprises: constructing an augmented Lagrange function based on the quadratic constrained binary optimization problem, reducing the augmented Lagrange function, and converting the quadratic constrained binary optimization problem into the quadratic unconstrained binary optimization problem; and the solving the quadratic unconstrained binary optimization problem on an Ising machine to obtain an optimal solution to the quadratic unconstrained binary optimization problem comprises: solving the quadratic unconstrained binary optimization problem on the Ising machine, updating coefficients in the augmented Lagrange function based on a solution result, converting to obtain a new quadratic unconstrained binary optimization problem and solving based on the Ising machine, and obtaining the optimal solution to the quadratic unconstrained binary optimization problem after constraints are satisfied and a loss function converges.

In a possible implementation, the modeling supervised learning of the multi-layer feedforward quantized neural network as a quadratic constrained binary optimization problem comprises: modeling the supervised learning of the multi-layer feedforward quantized neural network as a quadratic constrained binary optimization problem based on a loss function of the quantized neural network, an inequality constraint, an equality constraint, and an encoded optimization variable, where an objective function of the quadratic constrained binary optimization problem is the loss function of the quantized neural network, the equality constraint represents a linear transformation in a feedforward topology of the quantized neural network, and the inequality constraint represents an activation function in the feedforward topology of the quantized neural network.

In a possible implementation, the optimization variables comprise a quantized weight of each layer in the quantized neural network, a quantization bias of each layer, a value of each layer before activation, a value of each layer after activation, and a predicted value of the sample.

In a possible implementation, the constructing an augmented Lagrange function based on a quadratic constrained binary optimization problem, and reducing the augmented Lagrange function, and converting the quadratic constrained binary optimization problem into a quadratic unconstrained binary optimization problem comprises: constructing the augmented Lagrange function for a loss function and a constraint condition in the quadratic constrained binary optimization problem; and reducing the augmented Lagrange function by using a Rosenberg reduction method, and converting the quadratic constrained binary optimization problem into the quadratic unconstrained binary optimization problem.

In a possible implementation, the reducing the augmented Lagrange function by using a Rosenberg reduction method, and converting the quadratic constrained binary optimization problem into the quadratic unconstrained binary optimization problem comprises: determining a quadratic term factor that appears most frequently in the augmented Lagrange function, and replacing the quadratic term factor with an auxiliary binary variable; adding the Rosenberg polynomial as a penalty term to the original loss function; and iteratively performing the Rosenberg reduction method until an order of the augmented Lagrange function is reduced to quadratic, to obtain a quadratic loss function, and converting the quadratic constrained binary optimization problem into the quadratic unconstrained binary optimization problem.

In a possible implementation, the constructing an augmented Lagrange function for an objective function and a constraint condition in a quadratic constrained binary optimization problem comprises: multiplying a difference between two ends of an equality constraint by a Lagrange multiplier for the equality constraint to obtain a linear penalty term for the equality constraint; multiplying a difference between two ends of an inequality constraint by a Lagrange multiplier for the inequality constraint to obtain a linear penalty term for the inequality constraint; introducing a penalty coefficient for the equality constraint, and multiplying a square of a difference between two ends of the equality constraint by a penalty coefficient for the equality constraint to obtain a quadratic penalty term for the equality constraint; introducing a penalty coefficient for the inequality constraint, and multiplying a square of a difference between two ends of the inequality constraint by a penalty term for the inequality constraint to obtain a quadratic penalty term for the inequality constraint; and adding the linear penalty term and the quadratic penalty term for the equality constraint and the inequality constraint to a loss function to obtain the augmented Lagrange function.

In a possible implementation, the updating the coefficient in the augmented Lagrange function based on the solution result comprises: updating the Lagrange multiplier for the equality constraint and the Lagrange multiplier for the inequality constraint based on the solution result.

In a possible implementation, the updating the Lagrange multiplier for the equality constraint and the Lagrange multiplier for the inequality constraint based on the solution result comprises: determining a value of a difference between two ends of the equality constraint and a value of a difference between two ends of the inequality constraint based on the solution result; updating the Lagrange multiplier for the equality constraint to a sum of (i) a product of a difference between two ends of the equality constraint term and a penalty coefficient for the equality constraint, and (ii) an original Lagrange multiplier for the equality constraint; and when the product of the difference between two ends of the inequality constraint term and the penalty coefficient for the inequality constraint is not greater than 0, updating the Lagrange multiplier for the inequality constraint to a sum of (i) a product of the difference between two ends of the inequality constraint term and the penalty coefficient for the inequality constraint, and (ii) an original Lagrange multiplier for the inequality constraint, otherwise, updating the Lagrange multiplier for the inequality constraint to 0.

In a possible implementation, the inequality constraint comprises a same-sign constraint for values of each layer before activation and after activation and a constraint when a boundary condition is satisfied.

In a possible implementation, the encoded optimization variable is obtained by encoding the optimization variable by using a binary representation rule, and the binary representation rule comprises: limiting a variable value range to a specific upper and lower bound range by using a binary representation rule of decimal.

In a possible implementation, the method further comprises: limiting linear weights of the multi-layer feedforward quantized neural network except the last layer to +1 or −1; freezing bias terms of the multi-layer feedforward quantized neural network except the first layer and the last layer; and limiting linear weights of the last layer of the multi-layer feedforward quantized neural network and bias terms of the first layer and the last layer to quantized values with a specific bit width.

According to another aspect of the present application, a multi-layer feedforward neural network training system for an Ising machine is provided. The system comprises: a learning task constructing part configured to model supervised learning of a multi-layer feedforward quantized neural network as a quadratic constrained binary optimization problem; a problem form converting part configured to convert the quadratic constrained binary optimization problem into a quadratic unconstrained binary optimization problem; a network parameter solving part configured to solve the quadratic unconstrained binary optimization problem on an Ising machine to obtain an optimal solution to the quadratic unconstrained binary optimization problem; and a network parameter decoding part configured to decode the optimal solution to obtain parameters of the trained multi-layer feedforward neural network.

In a possible implementation, the learning task constructing part is configured to: represent an activation function in the feedforward topology of the quantized neural network as an inequality constraint, and represent a linear transformation in the feedforward topology of the quantized neural network as an equality constraint; and model supervised learning of the multi-layer feedforward quantized neural network as a quadratic constrained binary optimization problem based on the loss function of the quantized neural network, the constraint condition, and the encoded optimization variable, where an objective function of the quadratic constrained binary optimization problem is the loss function of the quantized neural network. The constraint conditions comprise equality constraints and inequality constraints.

In a possible implementation, the learning task constructing part is configured to: represent an activation function in a feedforward topology of the quantized neural network as an inequality constraint, and represent a linear transformation in the feedforward topology of the quantized neural network as an equality constraint; and convert the inequality constraint into the equality constraint by using an auxiliary variable; and
The supervised learning of the multi-layer feedforward quantized neural network is modeled as a quadratic constrained binary optimization problem based on the loss function of the quantized neural network, the equality constraints, and the encoded optimization variables, and the objective function of the quadratic constrained binary optimization problem is the loss function of the quantized neural network.

In a possible implementation, the optimization variables comprise a quantized weight of each layer in the quantized neural network, a quantization bias of each layer, a value of each layer before activation, a value of each layer after activation, a predicted value of a sample, and an auxiliary variable.

In a possible implementation, the problem form converting part is configured to: convert the inequality constraint into an equality constraint by using an auxiliary variable; eliminate all equality constraints in the quadratic constrained binary optimization problem by using a penalty function method, and construct a high-order loss function, or construct an augmented Lagrange function based on the quadratic constrained binary optimization problem; and reduce the high-order loss function or the augmented Lagrange function by using a Rosenberg order reduction method, and convert the quadratic constrained binary optimization problem into a quadratic unconstrained binary optimization problem. The high-order loss function may be a penalty function.

In a possible implementation, the problem form converting part is configured to: eliminate all equality constraints in the quadratic constrained binary optimization problem by using a penalty function method, and construct a penalty function; and reduce the penalty function by using a Rosenberg order reduction method, and convert the quadratic constrained binary optimization problem into the quadratic unconstrained binary optimization problem.

In a possible implementation, the eliminating all equality constraints in the quadratic constrained binary optimization problem by using a penalty function method to construct a high-order loss function comprises: calculating the difference between the two ends of the equality constraints, and adding a square of the difference to the loss function as a penalty term; and introducing a penalty coefficient to the penalty term in the loss function to obtain the high-order loss function.

In a possible implementation, the reducing the high-order loss function or the augmented Lagrange function by using a Rosenberg order reduction method, and converting the quadratic constrained binary optimization problem into a quadratic unconstrained binary optimization problem comprises: determining a quadratic term factor that appears most frequently in the high-order loss function or the augmented Lagrange function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, converting the quadratic constrained binary optimization problem into a quadratic unconstrained binary optimization problem.

In a possible implementation, the reducing the penalty function by using a Rosenberg order reduction method, and converting the quadratic constrained binary optimization problem into the quadratic unconstrained binary optimization problem, comprises: determining a quadratic term factor that occurs most frequently in the penalty function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, and converting the quadratic constrained binary optimization problem into a quadratic unconstrained binary optimization problem.

In a possible implementation, the learning task constructing part is configured to: construct an augmented Lagrange function based on the quadratic constrained binary optimization problem, reduce the augmented Lagrange function, and convert the quadratic constrained binary optimization problem into a quadratic unconstrained binary optimization problem; and the network parameter solving part is configured to: solve the quadratic unconstrained binary optimization problem on an Ising machine, update a coefficient in the augmented Lagrange function based on a solution result, convert to obtain a new quadratic unconstrained binary optimization problem, and solve based on the Ising machine, and obtain an optimal solution to the quadratic unconstrained binary optimization problem after a constraint is satisfied and a loss function converges.

In a possible implementation, the learning task constructing part is configured to model supervised learning of the multi-layer feedforward quantized neural network as a quadratic constrained binary optimization problem based on a loss function of the quantized neural network, an inequality constraint, an equality constraint, and an encoded optimization variable, where an objective function of the quadratic constrained binary optimization problem is the loss function of the quantized neural network, the equality constraint represents a linear transformation in a feedforward topology of the quantized neural network, and the inequality constraint represents an activation function in the feedforward topology of the quantized neural network.

In a possible implementation, the optimization variables comprise a quantized weight of each layer in the quantized neural network, a quantization bias of each layer, a value of each layer before activation, a value of each layer after activation, and a predicted value of the sample.

In a possible implementation, the constructing an augmented Lagrange function based on a quadratic constrained binary optimization problem, and reducing the augmented Lagrange function, and converting the quadratic constrained binary optimization problem into a quadratic unconstrained binary optimization problem comprises: constructing the augmented Lagrange function for a loss function and a constraint condition in the quadratic constrained binary optimization problem; and reducing the augmented Lagrange function by using a Rosenberg reduction method, and converting the quadratic constrained binary optimization problem into the quadratic unconstrained binary optimization problem.

In a possible implementation, the reducing the augmented Lagrange function by using a Rosenberg reduction method, and converting the quadratic constrained binary optimization problem into the quadratic unconstrained binary optimization problem comprises: determining a quadratic term factor that appears most frequently in the augmented Lagrange function, and replacing the quadratic term factor with an auxiliary binary variable; adding the Rosenberg polynomial as a penalty term to the original loss function; and iteratively performing the Rosenberg reduction method until an order of the augmented Lagrange function is reduced to quadratic, to obtain a quadratic loss function, and converting the quadratic constrained binary optimization problem into the quadratic unconstrained binary optimization problem.

In a possible implementation, the constructing an augmented Lagrange function for an objective function and a constraint condition in a quadratic constrained binary optimization problem comprises: multiplying a difference between two ends of an equality constraint by a Lagrange multiplier for the equality constraint to obtain a linear penalty term for the equality constraint; multiplying a difference between two ends of an inequality constraint by a Lagrange multiplier for the inequality constraint to obtain a linear penalty term for the inequality constraint; introducing a penalty coefficient for the equality constraint, and multiplying a square of a difference between two ends of the equality constraint by a penalty coefficient for the equality constraint to obtain a quadratic penalty term for the equality constraint; introducing a penalty coefficient for the inequality constraint, and multiplying a square of a difference between two ends of the inequality constraint by a penalty term for the inequality constraint to obtain a quadratic penalty term for the inequality constraint; and adding the linear penalty term and the quadratic penalty term for the equality constraint and the inequality constraint to a loss function to obtain the augmented Lagrange function.

In a possible implementation, the system further comprises a coefficient updating part configured to update the Lagrange multiplier for the equality constraint and the Lagrange multiplier for the inequality constraint based on the solution result.

In a possible implementation, the updating the Lagrange multiplier for the equality constraint and the Lagrange multiplier for the inequality constraint based on the solution result comprises: determining a value of a difference between two ends of the equality constraint and a value of a difference between two ends of the inequality constraint based on the solution result; updating the Lagrange multiplier for the equality constraint to a sum of (i) a product of a difference between two ends of the equality constraint term and a penalty coefficient for the equality constraint, and (ii) an original Lagrange multiplier for the equality constraint; and when the product of the difference between two ends of the inequality constraint term and the penalty coefficient for the inequality constraint is not greater than 0, updating the Lagrange multiplier for the inequality constraint to a sum of (i) a product of the difference between two ends of the inequality constraint term and the penalty coefficient for the inequality constraint, and (ii) an original Lagrange multiplier for the inequality constraint, otherwise, updating the Lagrange multiplier for the inequality constraint to 0.

In a possible implementation, the inequality constraint comprises a same-sign constraint for values of each layer before activation and after activation and a constraint when a boundary condition is satisfied.

In a possible implementation, the encoded optimization variable is obtained by encoding the optimization variable by using a binary representation rule, and the binary representation rule comprises: limiting a variable value range to a specific upper and lower bound range by using a binary representation rule of decimal.

In a possible implementation, the system further comprises: a first weight limiting part, configured to limit linear weights of the multi-layer feedforward quantized neural network except the last layer to +1 or −1; a bias term freezing part, configured to freeze bias terms of the multi-layer feedforward quantized neural network except the first layer and the last layer; and a second weight limiting part, configured to limit the linear weights of the last layer of the multi-layer feedforward quantized neural network and the bias terms of the first layer and the last layer to quantized values with a specific bit width.

According to another aspect of the present application, a multi-layer feedforward neural network training system for an Ising machine is provided. The system comprises: a host, configured to model supervised learning of a multi-layer feedforward quantized neural network as a quadratic constrained binary optimization problem; convert the quadratic constrained binary optimization problem into a quadratic unconstrained binary optimization problem; send the quadratic unconstrained binary optimization problem to be solved to an Ising machine for solving; receive a solution result sent by the Ising machine, and obtain an optimal solution to the quadratic unconstrained binary optimization problem based on the solution result; and decode the optimal solution to obtain parameters of the trained multi-layer feedforward neural network; and the Ising machine, configured to solve the quadratic unconstrained binary optimization problem sent by the host, and send the solution result to the host.

According to another aspect of the present application, an electronic apparatus is provided, comprising: a processor; and a memory for storing processor-executable instructions, wherein the processor is configured to implement the above method when executing the instructions stored in the memory.

According to another aspect of the present application, a computer-readable storage medium is provided, storing computer program instructions, wherein the computer program instructions, when executed by a processor, implementing the above method.

According to another aspect of the present application, a computer program product is provided, comprising computer-readable code or a non-volatile computer-readable storage medium carrying computer-readable code, where when the computer-readable code runs in a processor of an electronic apparatus, the processor in the electronic apparatus executes the foregoing method.

According to the embodiments of the present application, the supervised learning of the multi-layer feedforward quantized neural network is modeled as a quadratic constrained binary optimization problem; the quadratic constrained binary optimization problem is converted into a quadratic unconstrained binary optimization problem; the quadratic unconstrained binary optimization problem is solved on an Ising machine to obtain an optimal solution to the quadratic unconstrained binary optimization problem; and the optimal solution is decoded to obtain the parameters of the trained multi-layer feedforward neural network. According to the embodiments, efficient and fast solution can be implemented on the Ising machine to train the multi-layer feedforward neural network, the scheme reduces the use of spin numbers, simplifies the difficulty of problem solution, and can solve large-scale training problems.

Other features and aspects of the present application will become apparent from the following detailed description of exemplary embodiments with reference to the accompanying drawings.

### BRIEF DESCRIPTION OF THE DRAWINGS

The accompanying drawings, which are incorporated in and constitute a part of this specification, illustrate exemplary embodiments, features, and aspects of the present application together with the description and serve to explain the principles of the present application.

FIG. 1 shows a training framework diagram of a multi-layer feedforward neural network for an Ising machine according to an embodiment of the present application.

FIG. 2 shows a training framework diagram of a multi-layer feedforward neural network for an Ising machine according to an embodiment of the present application.

FIG. 3 shows a flowchart of a multi-layer feedforward neural network training method for Ising machine according to an embodiment of the present application.

FIG. 4 is a structural diagram of a multi-layer quantized neural network according to an embodiment of the present application.

FIG. 5 shows a schematic diagram of a verification process in the MNIST dataset according to an embodiment of the present disclosure.

FIG. 6 shows a loss function histogram for optimization training on an MNIST dataset according to an embodiment of the present application.

FIG. 7 shows a confusion matrix diagram for image classification verification on an MNIST dataset according to an embodiment of the present application.

FIG. 8 shows a structural diagram of a multi-layer feedforward neural network training system for Ising machine according to an embodiment of the present application.

### DETAILED DESCRIPTION

Various exemplary embodiments, features, and aspects of the present application will be described in detail below with reference to the accompanying drawings. The same reference numbers in the drawings indicate functionally the same or similar elements. While the various aspects of the embodiments are presented in drawings, the drawings are not necessarily drawn to scale unless specifically indicated. The word “exemplary” is used exclusively herein to mean “serving as an example, embodiment, or illustration.” Any embodiment described herein as “exemplary” is not necessarily to be construed as preferred or advantageous over other embodiments. In addition, to better describe the present application, many specific details are provided in the following specific implementations. A person skilled in the art should understand that the present application can also be implemented without some specific details. In some examples, methods, means, elements, and circuits well known to those skilled in the art are not described in detail, so as to highlight the subject matter of the present application.

At present, the huge computational overhead for training deep neural networks has become a key bottleneck in the development of artificial intelligence. The traditional gradient-based back propagation training method encounters many problems such as vanishing gradients and getting trapped in local optima, and this training method requires a large number of graphic processing units (GPU) to efficiently update the model. As a dedicated quantum computer, Ising machines have achieved a large number of spin bits, showing the potential for training neural networks on Ising machines. So far, Ising machines have been used for some machine learning tasks, such as training of support vector machines and training of clustering models. Meanwhile, in the field of neural networks, Ising machine can be used to train Boltzmann Machine and Dynamical Energy Network, while neither of these two types of networks belongs to feedforward networks. Because of the powerful representation capability, fast inference capability, and flexible connection structure of the feedforward network, a multi-layer feedforward network is a neural network type most widely used in industry. The current challenge is how to efficiently and quickly solve on an Ising machine to realize the training of a multi-layer feedforward neural network.

In view of this, the present application provides a multi-layer feedforward neural network training method and system for Ising machine. The multi-layer feedforward neural network training method for Ising machine in the embodiments of the present application models the supervised learning of the multi-layer feedforward quantized neural network as a quadratic constrained binary optimization problem, converts the quadratic constrained binary optimization problem into a quadratic unconstrained binary optimization problem, solves the quadratic unconstrained binary optimization problem on the Ising machine to obtain an optimal solution to the quadratic unconstrained binary optimization problem, and decodes the optimal solution to obtain the parameters of the trained multi-layer feedforward neural network. According to the embodiments, efficient and fast solution can be implemented on the Ising machine to train the multi-layer feedforward neural network, the scheme reduces the use of spin numbers, simplifies the difficulty of problem solution, and can solve large-scale training problems.

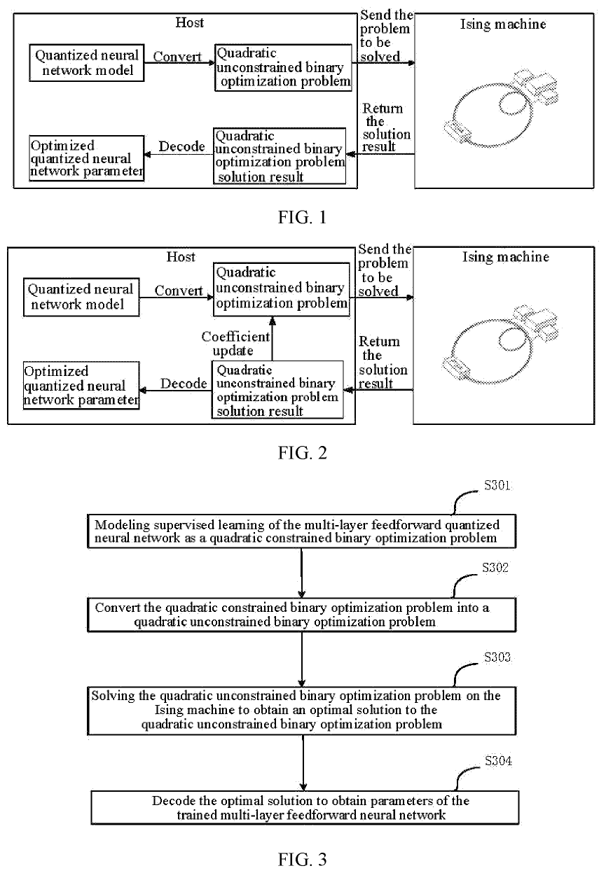

FIG. 1 shows a training framework diagram of a multi-layer feedforward neural network for an Ising machine according to an embodiment of the present application. As shown in FIG. 1, the method in an embodiment of the present application may be deployed in a multi-layer feedforward neural network training system, and the multi-layer feedforward neural network training system may be deployed in a terminal apparatus or a server. The present application does not limit a type of the terminal apparatus or the server.

The multi-layer feedforward neural network training system may comprise a host and an Ising machine, the host (that is, a processor in a terminal apparatus or a server) may execute an operation other than “solving a quadratic unconstrained binary optimization problem”, and the Ising machine is configured to solve the quadratic unconstrained binary optimization problem. In the multi-layer feedforward neural network training system, the supervised learning of the multi-layer feedforward quantized neural network model may be modeled as a quadratic constrained binary optimization problem, and it may be converted to obtain a quadratic unconstrained binary optimization problem; wherein, in the process of converting into the quadratic unconstrained binary optimization problem, the QNN may be expressed as a quadratic constrained binary optimization ((QCBO)) problem, and the QCBO problem is converted into a quadratic unconstrained binary optimization (QUBO) problem.

The host may send the quadratic unconstrained binary optimization problem to be solved to the Ising machine for solving; the Ising machine may solve the quadratic unconstrained binary optimization problem sent by the host to obtain an optimal solution to the quadratic unconstrained binary optimization problem and return the optimal solution to the host; and then the host decodes the optimal solution to the quadratic unconstrained binary optimization problem to obtain parameters of the trained multi-layer feedforward neural network. Therefore, training of the multi-layer feedforward neural network is implemented.

FIG. 2 shows a training framework diagram of a multi-layer feedforward neural network for an Ising machine according to an embodiment of the present application. As shown in FIG. 2, in a scenario in which a scheme of an augmented Lagrange function is used, the method in an embodiment of the present application may be deployed in a multi-layer feedforward neural network training system, and the multi-layer feedforward neural network training system may be deployed in a terminal apparatus or a server. The present application does not limit a type of the terminal apparatus or the server.

The multi-layer feedforward neural network training system may comprise a host and an Ising machine, the host (that is, a processor in a terminal apparatus or a server) may execute an operation other than “solving a quadratic unconstrained binary optimization problem”, and the Ising machine is configured to solve the quadratic unconstrained binary optimization problem. In the multi-layer feedforward neural network training system, the supervised learning of the multi-layer feedforward quantized neural network model may be modeled as a quadratic constrained binary optimization problem, and it may be converted to obtain a quadratic unconstrained binary optimization problem; wherein, in the process of converting into the quadratic unconstrained binary optimization problem, the QNN may be expressed as a quadratic constrained binary optimization (QCBO) problem, and the QCBO problem is converted into a quadratic unconstrained binary optimization (QUBO) problem through the Lagrange function method and the Rosenberg reduction method.

The host can send the quadratic unconstrained binary optimization problem to be solved to the Ising machine for solving;
the Ising machine can solve the quadratic unconstrained binary optimization problem sent by the host to obtain a solution result of the quadratic unconstrained binary optimization problem, and send the solution result to the host;
the host may receive the solution result sent by the Ising machine, update the coefficient (i.e., the Lagrange multiplier) in the augmented Lagrange function based on the solution result, convert to obtain a new quadratic unconstrained binary optimization problem, and send the new quadratic unconstrained binary optimization problem to the Ising machine again for solution, iterate the above steps, and obtain the optimal solution to the quadratic unconstrained binary optimization problem after the constraints are satisfied and the objective function converges; finally, the host decodes the optimal solution to the quadratic unconstrained binary optimization problem to obtain the parameters of the trained multi-layer feedforward neural network. Therefore, training of the multi-layer feedforward neural network is implemented.

FIG. 3 shows a flowchart of a multi-layer feedforward neural network training method for Ising machine according to an embodiment of the present application. As shown in FIG. 3, the method may include:

Step S301: modeling supervised learning of the multi-layer feedforward quantized neural network as a quadratic constrained binary optimization problem.

The multi-layer feedforward quantized neural network (hereinafter referred to as quantized neural network) is a special form of the multi-layer feedforward neural network. This step may be executed by the host, and the host may be any type of processor, such as a central processing unit (CPU). Supervised learning of a multi-layer feedforward quantized neural network may be modeled as a quadratic constrained binary optimization (QCBO) problem on a training dataset D and a quantized neural network (QNN) parameter θ.

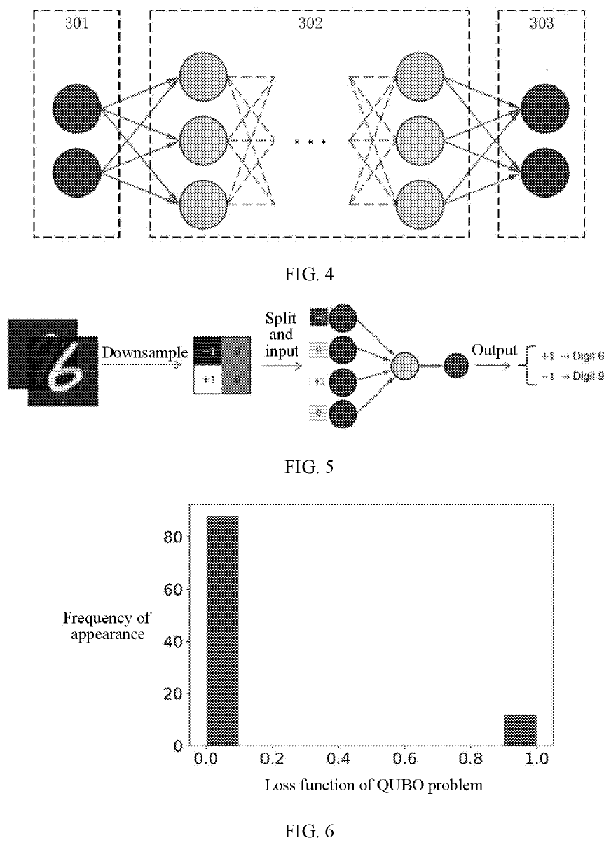

In an embodiment of the present application, some simplifications and limitations are made to the QNN, comprising: limiting linear weights of the multi-layer feedforward quantized neural network except the last layer to +1 or −1, and freezing bias terms of the multi-layer feedforward quantized neural network except the first layer and the last layer. In addition, the linear weights of the last layer of the multi-layer feedforward quantized neural network and the bias terms of the first layer and the last layer are limited to quantized values with a specific bit width, thereby obtaining quantized values with higher precision, because these layers play a more important role in the prediction of the neural network. It may be assumed that f is a multi-layer quantized neural network having a quantization parameter θ, and referring to FIG. 4, a structural diagram of a multi-layer quantized neural network according to an embodiment of the present application is shown. As shown in FIG. 4, 301 represents an input layer neuron, 302 represents a hidden layer neuron, and 303 represents an output layer neuron.

A problem corresponding to supervised learning of the multi-layer feedforward quantized neural network may be expressed as:

$${θ}^{*} = arg {min}_{θ} \frac{1}{N} {\sum }_{i = 1}^{N} {( {y}_{i} - f ( {x}_{i} ) )}^{2} ,$$

θ represents the quantized neural network parameter to be solved (i.e., the parameter of 301-303 in FIG. 4), θ* represents the optimal quantized neural network parameter, N represents the size of the training dataset, and the input and label of the i-th sample are respectively xᵢϵXⁿ, yᵢϵY^{m}. f(x)=f^{(L)} . . . f⁽²⁾°f⁽¹⁾(x), where L represents the total number of layers of the quantized neural network, and the sign ° represents the function composite operation, that is, the output of the previous layer operation is used as the input of the next layer operation, the operation of the k-th layer is f^{(k)} (x)=g(W^{(k)}x+b^{(k)}, g is the activation function, W^{(k)} represents the quantization weight of the k-th layer, and b^{(k)} represents the quantization bias of the k-th layer, and the quantized neural network parameter θ={W^{(k)}|k=1, 2, . . . , L}∪{b⁽¹⁾, b^{(L)}} to be solved.

The QCBO problem is suitable for a back propagation training method, but is not suitable for training on an Ising machine, and there are two main reasons: first, the variable domain does not match, and in order to use the Ising machine, the training needs to be expressed as a QUBO problem, where only binary variables should be involved, but the network parameter θ usually contains non-binary variables; second, the loss function is highly nonlinear, and the existence of the nonlinear activation function g makes it difficult to represent the loss function as a quadratic loss.

Step S301 may include: representing an activation function in the feedforward topology of the quantized neural network as an inequality constraint, and representing a linear transformation in the feedforward topology of the quantized neural network as an equality constraint; and modeling supervised learning of the multi-layer feedforward quantized neural network as a quadratic constrained binary optimization problem based on the loss function of the quantized neural network, the constraint condition, and the encoded optimization variable, where an objective function of the quadratic constrained binary optimization problem is the loss function of the quantized neural network.

The constraint conditions comprise equality constraints and inequality constraints.

In an embodiment of the present application, a method of a penalty function is utilized. In this scenario, step S301 may include: representing an activation function in a feedforward topology of the quantized neural network as an inequality constraint, and representing a linear transformation in the feedforward topology of the quantized neural network as an equality constraint; converting the inequality constraint into the equality constraint by using an auxiliary variable; and modeling supervised learning of the multi-layer feedforward quantized neural network as a quadratic constrained binary optimization problem based on a loss function of the quantized neural network, the equality constraint, and an encoded optimization variable, where an objective function of the quadratic constrained binary optimization problem is the loss function of the quantized neural network. Where, for linear transformation, an equality constraint is adopted:

$${W}^{( k )} {a}^{( k - 1 )} + {b}^{( k )} = {s}^{( k )}$$

Where W^{(k)} and b^{(k)} are the weight and bias of the k-th layer, S^{(k)} is the value of the k-th layer before activation, and a^{(k-1)} is the value of the k-1-th layer after activation. For the activation function, a sign function is used as the activation function of the network, that is:

$$sign ( x ) = \{ \begin{matrix}+ 1 , x \geq 0 \\ - 1 , x < 0\end{matrix} .$$

where x denotes the input of the sign function. For an activation function, it can be modeled as the following two constraints:

$${a}^{( k )} \text{?} {s}^{( k )} = {r}^{( k )}$$

$${a}^{( k )} + 2 {r}^{( k )} \geq 1$$

An inequality constraint (which may be referred to as an activation constraint and represents a transformation process of the activation function in the feedforward system) corresponding to the activation function may comprise a same-sign constraint (corresponding to the first constraint in the foregoing formula) for values of each layer before activation and after activation and a constraint satisfying a boundary condition (corresponding to the second constraint in the foregoing formula).
where s^{(k)}ϵ [symbol] ^{H}, a^{(k)}ϵ{−1, +1}^{H} represents the value of the k-th layer before activation and the value of the k-th layer after activation, H represents the number of neural units of each hidden layer, and operation ⊙ represents element-wise multiplication, and an auxiliary variable r^{(k)}ϵ [symbol] ^{H} is introduced in the method using the penalty function. The above constraint α^{(k)} ⊙s^{(k)}=r^{(k)} guarantees that a(k) and (k) have the same sign because r^{(k)} is a non-negative integer. Where this constraint is satisfied, the value of r^{(k)} will be equal to the absolute value of s^{(k)}. When s^{(k)}=0, the above constraint a^{(k)}+2r^{(k)}≥1 guarantees a^{(k)}=+1.

In order to process the constraints more conveniently later, an auxiliary variable t^{(k)}ϵ [symbol] ^{H} is also introduced in the present application, and the inequality constraints are converted into equality constraints:

$${a}^{( k )} + 2 {r}^{( k )} = 1 + {t}^{( k )}$$

In an implementation of the present application, an augmented Lagrange function method is used. In this scenario, step S301 may include: modeling supervised learning of the multi-layer feedforward quantized neural network as a quadratic constrained binary optimization problem based on the loss function of the quantized neural network, the inequality constraint, the equality constraint, and the encoded optimization variable.

An objective function of the quadratic constrained binary optimization problem is a loss function of the quantized neural network, an equality constraint represents linear transformation in a feedforward topology of the quantized neural network, an inequality constraint represents an activation function in the feedforward topology of the quantized neural network, and an encoded optimization variable is obtained by encoding the optimization variable by using a binary representation rule.

An equality constraint (which may be referred to as a linear constraint and represents a linear transformation process in a feedforward process) corresponding to the linear transformation may be:

$${W}^{( k )} {a}^{( k - 1 )} + {b}^{( k )} = {s}^{( k )} ,$$

where s^{(k)} is the value of the k-th layer before activation, and a^{(k-1)} is the value of the k−1-th layer after activation.

The activation function may be a sign function (sign function), i.e.:

$$sign ( x ) = \{ \begin{matrix}+ 1 , & x \geq 0 \\ - 1 , & x < 0\end{matrix} ,$$

where x denotes the input of the sign function. An inequality constraint (which may be referred to as an activation constraint and represents a transformation process of an activation function in a feedforward system) corresponding to an activation function may comprise a same-sign constraint for the values of each layer before activation and after activation and a constraint that satisfies a boundary condition. For an activation function, it can be modeled as the following two inequality constraints:

$$- {a}_{i}^{( k )} \text{?} {s}_{i}^{( k )} \leq 0 ,$$

$$∀ i ,$$

$$1 - 2 {a}_{i}^{( k )} \text{?} {s}_{i}^{( k )} - {a}_{i}^{( k )} \leq 0 ,$$

$$∀ i ,$$

The first inequality constraint is the same-sign constraint for the values of each layer before activation and after activation, where

$${a}_{i}^{( k )}$$

represents the value of the k-th layer after activation when the i-th sample is input, and

$${s}_{i}^{( k )}$$

represents the value of the k-th layer before activation when the i-th sample is input. Through this inequality constraint,

$${a}_{i}^{( k )}$$

$$and$$

$${s}_{i}^{( k )}$$

can be made to have the same sign.

The second inequality constraint is a constraint when the boundary condition is satisfied, that is, a zero-point constraint for the sign function, and when the boundary condition is satisfied (that is, when

$${s}_{i}^{( k )}$$

is equal to 0), a value of

$${a}_{i}^{( k )}$$

is +1 by using the inequality constraint.

In an implementation of the present application, a penalty function is used. In this scenario, the process of modeling the supervised learning of the QNN as a QCBO problem is as follows:

In the present application, training (that is, supervised learning) of the QNN is represented as a combined optimization problem. It is assumed that there is a dataset D, where an input and a label of the i-th sample are respectively xᵢϵXⁿ, yᵢϵY^{m}, where X=[−2^{B},2^{B}], Y=[−1,1]. B here represents the bit width of the input data. By introducing scale factors, typical classification and regression problems can be converted into such datasets without loss of generality.

Before training, the input xᵢ should be quantized to an integer variable x̅ᵢ by rounding. The trainable parameter of the network is θ={W^{(k)}|k=1, 2, . . . , L}∪{b⁽¹⁾, b^{(L)}}, and L represents a total quantity of layers of the neural network. In subsequent variables of this disclosure, subscript i represents the value of the corresponding variable when the i-th sample in the dataset is input into the network.

In a process of modeling supervised learning of a QNN as a QCBO problem, a loss function in the supervised learning may be represented as a mean squared error (MSE):

$${L}_{MSE} = \frac{1}{N} {\sum }_{i = 1}^{N} {( {y}_{i} - {\hat{y}}_{i} )}^{2}$$

where ŷᵢ is the predicted value of sample i, yᵢ is the label of the i-th sample, and N is the size of the training dataset.

Some of the aforementioned constraint conditions must be satisfied when minimizing the mean square error L_{MSE}, which are listed hierarchically below.

For the first layer, the following linear constraints and activation constraints should be satisfied, where the linear constraints represent the linear transformation process in the feedforward process, and the activation constraints represent the transformation process of the activation function in the feedforward system:

$${W}^{( 1 )} {\overline{x}}_{i} + {b}^{( 1 )} = {s}_{i}^{( 1 )} ,$$

$${a}_{i}^{( 1 )} \text{?} {s}_{i}^{( 1 )} = {r}_{i}^{( 1 )} ,$$

$${a}_{i}^{( 1 )} + 2 {r}_{i}^{( 1 )} = 1 + {t}_{i}^{( 1 )} ,$$

$$∀ i$$

where x̅ᵢ represents the input i quantized to an integer variable by rounding. W⁽¹⁾ represents the quantized weight of the first layer, b⁽¹⁾ represents the quantization bias of the first layer,

$${a}_{i}^{( 1 )}$$

represents the value of the first layer after activation when the i-th sample is input,

$${s}_{i}^{( 1 )}$$

represents the value of the first layer before activation when the i-th sample is input, and

$${r}_{i}^{( 1 )}$$

represents the auxiliary variable r of the first layer when the i-th sample is input, and

$${t}_{i}^{( 1 )}$$

represents the auxiliary variable t of the first layer when the i-th sample is input.

For the 2,3, . . . , L−1 layer, the following linear and activation constraints should be satisfied:

$${W}^{( k )} {a}_{i}^{( k - 1 )} + {b}^{( k )} = {s}_{i}^{( k )} ,$$

$${a}_{i}^{( k )} \text{?} {s}_{i}^{( k )} = {r}_{i}^{( k )} ,$$

$$∀ i$$

where W^{(k)} and b(k) are a weight and a bias of the k-th layer,

$${s}_{i}^{( k )}$$

is a value of the k-th layer before activation when the i-th sample is input,

$${a}_{i}^{( k - 1 )}$$

is a value of the k-1-th layer after activation when the i-th sample is input,

$${a}_{i}^{( k )}$$

is a value of the k-th layer after activation when the i-th sample is input, and

$${r}_{i}^{( k )}$$

represents an auxiliary variable of the k-th layer when the i-th sample is input.

For the last layer of the model (i.e., the L-th layer, the network output layer), the linear constraint should be satisfied:

$${W}^{( L )} {a}_{i}^{( L - 1 )} + {b}^{( L )} = {\hat{y}}_{i} , ∀ i$$

where W^{(L)} represents the quantized weight of the L-th layer,

$${a}_{i}^{( L - 1 )}$$

represents the activated value of the L−1-th layer when the i-th sample is input, and b^{(L)} represents the quantization bias of the L-th layer.

The above MSE loss function and all the constraint conditions constitute an optimization problem, wherein the objective function of the quadratic constrained binary optimization problem is the loss function of the quantized neural network (i.e., the above MSE loss function).

The optimization variables (that is, decision variables) of the QCBO problem comprise a quantized weight of each layer in the quantized neural network, a quantization bias of each layer, a value of each layer before activation, a value of each layer after activation, a predicted value of a sample, and an auxiliary variable, which are expressed as:

$$σ = \{ θ , {s}_{i}^{( k )} , {r}_{i}^{( k )} , {t}_{i}^{( 1 )} , {a}_{i}^{( k )} , {\hat{y}}_{i} \vert k = 1.2 , … , L , i = 1 , 2 , … , N \}$$

Next, all decision variables are encoded with binary bits, and the value range of each bit is {0, 1}, corresponding to one spin on the Ising machine. This encoding scheme is implemented by a binary representation rule of decimal. Therefore, an encoded optimization variable may be obtained, and the binary representation rule comprises: limiting a variable value range to a specific upper and lower bound range by using a binary representation rule of decimal. The encoding schemes for all variables are listed hierarchically below.

For the first layer, all decision variables include:

$${W}^{( 1 )} , {b}^{( 1 )} , {s}_{i}^{( 1 )} , {r}_{i}^{( 1 )} , {t}_{i}^{( 1 )} , {a}_{i}^{( 1 )} , ∀ i = 1 , 2 , … , N ,$$

encoded by the following binary variables:

$${σ}_{w}^{( 1 )} , {σ}_{b}^{( 1 )} , {σ}^{( 1 )} , {σ}_{r}^{( 1 )} , {σ}_{t}^{( 1 )} , {σ}_{a}^{( 1 )} .$$

The specific expression of each variable is as follows:

$${W}^{( 1 )} = 2 \cdot {σ}_{w}^{( 1 )} - 1$$

$${b}^{( 1 )} = {\sum }_{j = 1}^{{log}_{2} n {2}^{B} + 1} {2}^{j} \cdot {σ}_{b}^{( 1 )} ( j )$$

$${s}_{i}^{( 1 )} = {\sum }_{j = 1}^{{log}_{2} n {2}^{B} + 1} {2}^{j} \cdot {σ}_{s}^{( 1 )} ( i , j ) - n {2}^{B} , ∀ i$$

$${r}_{i}^{( 1 )} = {\sum }_{j = 1}^{{log}_{2} n {2}^{B} + 1} {2}^{j} \cdot {σ}_{r}^{( 1 )} ( i , j ) , ∀ i$$

$${t}_{i}^{( 1 )} = {\sum }_{j = 1}^{{log}_{2} n {2}^{B} + 1} {2}^{j} \cdot {σ}_{t}^{( 1 )} ( i , j ) , ∀ i$$

$${a}_{i}^{( 1 )} = 2 \cdot {σ}_{a}^{( 1 )} ( i ) - 1 , ∀ i$$

where

$${σ}_{w}^{( 1 )}$$

may represent the binary code of the variable W⁽¹⁾,

$${σ}_{b}^{( 1 )} ( j )$$

may represent the value of the j-th bit in the binary code of the variable b⁽¹⁾,

$${σ}_{s}^{( 1 )} ( i , j )$$

may represent the value of the j-th bit in the binary code of the variable

$${s}_{i}^{( 1 )} , {σ}_{r}^{( 1 )} ( i , j )$$

may represent the value of the j-th bit in the binary code of the variable

$${r}_{i}^{( 1 )} , {σ}_{t}^{( 1 )} ( i , j )$$

may represent the value of the j-th bit in the binary code of the variable

$${t}_{i}^{( 1 )} , and {σ}_{a}^{( 1 )} ( i )$$

may represent the binary code of the variable

$${a}_{i}^{( 1 )} .$$

n is the dimension of the input xᵢ, and B is the bit width of the input data.

The value range of the binary variable is:

$${σ}_{w}^{( 1 )} ∈ {\{ 0 , 1 \}}^{H \cdot n} ,$$

$${σ}_{b}^{( 1 )} ( j ) , {σ}_{s}^{( 1 )} ( i , j ) , {σ}_{r}^{( 1 )} ( i , j ) , {σ}_{t}^{( 1 )} ( i , j ) , {σ}_{a}^{( 1 )} ( i ) ∈ {\{ 0 , 1 \}}^{H} , ∀ i$$

For layer 2, 3, . . . , L−1, all decision variables include:

$${W}^{( k )} , {s}_{i}^{( k )} , {r}_{i}^{( k )} , {a}_{i}^{( k )} , ∀ i = 1 , 2 , … , N ,$$

Encoding is performed by the following binary variables:

$${σ}_{w}^{( k )} , {σ}_{s}^{( k )} , {σ}_{r}^{( k )} , {σ}_{a}^{( k )} .$$

The specific expression of each variable is as follows:

$${W}^{( k )} = 2 \cdot {σ}_{w}^{( k )} - 1$$

$${s}_{i}^{( k )} = {\sum }_{j = 0}^{{log}_{2} 4 H + 1} {2}^{j} \cdot {σ}_{s}^{( k )} ( i , j ) - 2 H , ∀ i$$

$${r}_{i}^{( k )} = {\sum }_{j = 0}^{{log}_{2} 2 H + 1} {2}^{j} \cdot {σ}_{r}^{( k )} ( i , j ) - 2 H , ∀ i$$

$${a}_{i}^{( k )} = 2 \cdot {σ}_{a}^{( k )} ( i ) - 1 , ∀ i$$

The value range of the binary variable is:

$${σ}_{w}^{( k )} ∈ {\{ 0 , 1 \}}^{H \cdot H} ,$$

$${σ}_{s}^{( k )} ( i , j ) , {σ}_{r}^{( k )} ( i , j ) , {σ}_{a}^{( k )} ( i ) ∈ {\{ 0 , 1 \}}^{H} , ∀ i ,$$

For the last layer, all decision variables include: W^{(L)}, b^{(L)}, ŷᵢ, ∀i=1, 2, . . . , N, encoded by the following binary variables:

$${σ}_{w}^{( L )} , {σ}_{b}^{( L )} , {σ}_{y} .$$

The specific expression of each variable is as follows:

$${W}^{( L )} = \frac{1}{{2}^{B}} ( {\sum }_{j = 0}^{B} {2}^{j} \cdot {σ}_{w}^{( L )} ( j ) - ( {2}^{B} - 1 ) )$$

$${b}^{( L )} = \frac{1}{{2}^{B}} ( {\sum }_{j = 0}^{{log}_{2} H {2}^{B + 1} + 1} {2}^{j} \cdot {σ}_{b}^{( L )} ( j ) - ( {2}^{B} - 1 ) )$$

$${\hat{y}}_{i} = \frac{1}{{2}^{B}} ( {\sum }_{j = 0}^{{log}_{2} ( H + 1 ) {2}^{B + 1} + 1} {2}^{j} \cdot {σ}_{y} ( i , j ) - ( H + 1 ) {2}^{B} ) , ∀ i$$

The value range of the binary variable is:

$${σ}_{w}^{( L )} ( j ) ∈ {\{ 0 , 1 \}}^{m \cdot H} ,$$

$${σ}_{b}^{( L )} ( j ) , {σ}_{y} ( i , j ) ∈ {\{ 0 , 1 \}}^{m} , ∀ i ,$$

In an embodiment of the present application, training of the quantized neural network is defined as a quadratic constrained binary optimization problem by using the foregoing scheme. This step comprises a constraint representation of the network topology and a binary representation of the optimization variables. The constraint representation technique represents the feedforward topology of a quantized neural network by using linear transformations and activation functions as equality constraints. The binary representation technology constructs all optimization variables based on binary representation rules of decimal numbers, thereby establishing a relationship between the optimization variables and spins of Ising machines.

In another embodiment of the present application, an augmented Lagrange function method is used. In this scenario, the process of modeling the supervised learning of the QNN as a QCBO problem is as follows:
unlike the method by using the penalty function, the method in an embodiment of the present application may directly construct the augmented Lagrange function by using the foregoing constraints subsequently, without converting the foregoing inequality constraints (the same-sign constraint and the zero-point constraint) into equality constraints and then constructing the augmented Lagrange function. In the present application, the foregoing inequality constraint does not need to be converted into an equality constraint, and an auxiliary variable does not need to be introduced to help conversion as in a method using a penalty function. In the present application, the subsequent construction of the augmented Lagrange function directly uses the inequality constraint without using the auxiliary variables, so that the use of the number of spin bits can also be reduced in the subsequent solution by using the Ising machine. In a process of modeling supervised learning of a QNN as a QCBO problem, a loss function in the supervised learning may be represented as a mean squared error (MSE):

$${L}_{MSB} = \frac{1}{N} {\sum }_{i = 1}^{N} {( {y}_{i} - {\hat{y}}_{i} )}^{2}$$

where ŷᵢ is the predicted value of sample i, yᵢ is the label of the i-th sample, and N is the size of the training dataset. When the mean square error L_{MSE} is minimized, the above linear constraint and activation constraint should be satisfied for layers 1 to L−1 of the model.

Some of the aforementioned constraint conditions must be satisfied when minimizing L_{MSE}, which are listed hierarchically below.

For the first layer, the following linear constraints and activation constraints should be satisfied, where the linear constraints represent the linear transformation process in the feedforward process, and the activation constraints represent the transformation process of the activation function in the feedforward system:

$${W}^{( 1 )} {x}_{i} + {b}^{( 1 )} = {s}_{i}^{( 1 )} ,$$

$$- {a}_{i}^{( 1 )} ⊙ {s}_{i}^{( 1 )} \leq 0 ,$$

$$1 - 2 {a}_{i}^{( 1 )} ⊙ {s}_{i}^{( 1 )} - {a}_{i}^{( 1 )} \leq 0 , ∀ i ,$$

For the 2,3, . . . , L−1 layer, the following linear and activation constraints should be satisfied:

$${W}^{( k )} {a}^{( k - 1 )} + {b}^{( k )} = {s}^{( k )} ,$$

$$- {a}_{i}^{( k )} ⊙ {s}_{i}^{( k )} \leq 0 ,$$

$$1 - 2 {a}_{i}^{( k )} ⊙ {s}_{i}^{( k )} - {a}_{i}^{( k )} \leq 0 , ∀ i ,$$

For the last layer of the model (i.e., the L-th layer, the network output layer), the linear constraint should be satisfied:

$${W}^{( L )} {a}_{i}^{( L - 1 )} + {b}^{( L )} = {\hat{y}}_{i} , ∀ i ,$$

where W^{(L)} represents the quantized weight of the L-th layer,

$${a}_{i}^{( L - 1 )}$$

represents the activated value of the L−1-th layer when the i-th sample is input, and b^{(L)} represents the quantization bias of the L-th layer.

The above MSE loss function and all the constraint conditions constitute an optimization problem, wherein the objective function of the quadratic constrained binary optimization problem is the loss function of the quantized neural network (i.e., the above MSE loss function).

The optimization variables (that is, decision variables) of the QCBO problem comprise a quantized weight of each layer in the quantized neural network, a quantization bias of each layer, a value of each layer before activation, a value of each layer after activation, and a predicted value of a sample. The optimization variable may be represented as:

$$\{ {W}^{( k )} , {b}^{( k )} , {s}_{i}^{( k )} , {a}_{i}^{( k )} , {y}_{i} \vert k = 1 , 2 , … L , i = 1 , 2 , … N \} .$$

L is the number of layers of the quantized neural network.

The optimization variable in an embodiment is also inconsistent with the optimization variable established in the method using the penalty function, and in the present application, because the inequality constraint does not need to be converted into the equality constraint in constraint expression, the optimization variable may not comprise two types of auxiliary variables required in the method using the penalty function, thereby further reducing the number of spin bits compared with the method using the penalty function. All optimization variables can be encoded with binary bits, and the value range of each bit is {0, 1}, which corresponds to one spin on Ising machine, so that the relationship between the optimization variables and the spins for Ising machine can be established. An encoded optimization variable may be obtained by encoding the optimization variable by using a binary representation rule, where the binary representation rule comprises: limiting a variable value range to a specific upper and lower bound range by using a binary representation rule of decimal.

The encoding schemes for all variables are listed hierarchically below.

For the first layer, all decision variables include:

$${W}^{( 1 )} , {b}^{( 1 )} , {s}_{i}^{( 1 )} , {a}_{i}^{( 1 )} , ∀ i = 1 , 2 , … , N ,$$

encoded by the following binary variables:

$${σ}_{w}^{( 1 )} , {σ}_{b}^{( 1 )} , {σ}_{s}^{( 1 )} , {σ}_{a}^{( 1 )} .$$

The expression of each variable is as follows:

$${W}^{( 1 )} = 2 \cdot {σ}_{w}^{( 1 )} - 1 ,$$

$${b}^{( 1 )} = {\sum }_{j = 0}^{⌊ {log}_{2} n {2}^{B} + 1 ⌋} {2}^{j} \cdot {σ}_{b}^{( 1 )} ( j ) ,$$

$${s}_{i}^{( 1 )} = {\sum }_{j = 0}^{⌊ {log}_{2} n {2}^{B + 1} + 1 ⌋} {2}^{j} \cdot {σ}_{s}^{( 1 )} ( i , j ) - n {2}^{B} , ∀ i ,$$

$${a}_{i}^{( 1 )} = 2 \cdot {σ}_{a}^{( 1 )} ( i ) - 1 , ∀ i ,$$

where

$${σ}_{w}^{( 1 )}$$

may represent the binary code of variable

$${W}^{( 1 )} , {σ}_{b}^{( 1 )} ( j )$$

may represent the value of the j-th bit in the binary code of variable

$${b}^{( 1 )} , {σ}_{s}^{( 1 )} ( i , j )$$

may represent the value of the j-th bit in the binary code of variable

$${s}_{i}^{( 1 )} , and {σ}_{a}^{( 1 )} ( i )$$

may represent the binary code of variable

$${a}_{i}^{( 1 )} .$$

n is the dimension of the input xᵢ, and B is the bit width of the input data.

The value range of the binary variable is:

$${σ}_{w}^{( 1 )} ∈ {\{ 0 , 1 \}}^{H \cdot n} ,$$

$${σ}_{b}^{( 1 )} ( j ) , {σ}_{s}^{( 1 )} ( i , j ) , {σ}_{a}^{( 1 )} ( i ) ∈ {\{ 0 , 1 \}}^{H} , ∀ i ,$$

For layer 2, 3, . . . L-1, all decision variables include:

$${W}^{( k )} , {s}_{i}^{( k )} , {a}_{i}^{( k )} , ∀ i = 1 , 2 , … , N ,$$

encoded by the following binary variables:

$${σ}_{w}^{( k )} , {σ}_{s}^{( k )} , {σ}_{a}^{( k )} .$$

The expression of each variable is as follows:

$${W}^{( k )} = 2 \cdot {σ}_{w}^{( k )} - 1 ,$$

$${s}_{i}^{( k )} = {\sum }_{j = 0}^{⌊ lo {g}_{2} 2 H ⌋} {2}^{j} \cdot {σ}_{s}^{( k )} ( i , j ) - 1 , ∀ i ,$$

$${a}_{i}^{( k )} = 2 \cdot {σ}_{a}^{( k )} ( i ) - 1 , ∀ i ,$$

The value range of the binary variable is:

$${σ}_{w}^{( k )} ∈ {\{ 0 , 1 \}}^{H \cdot H} ,$$

$${σ}_{s}^{( k )} ( i , j ) , {σ}_{a}^{( k )} ( i ) ∈ {\{ 0 , 1 \}}^{H} , ∀ i ,$$

For the last layer, all decision variables include: W^{(L)}, b^{(L)}, ŷᵢ, ∀i=1, 2, . . . , N, encoded by the following binary variables:

$${σ}_{w}^{( L )} , {σ}_{b}^{( L )} , {σ}_{y} .$$

The expression of each variable is as follows:

$${W}^{( L )} = \frac{1}{H} ( {\sum }_{j = 0}^{⌊ lo {g}_{2} 2 H ⌋} {2}^{j} \cdot {σ}_{w}^{( L )} ( j ) - H ) ,$$

$${b}^{( L )} = \frac{1}{H} ( {\sum }_{j = 0}^{⌊ lo {g}_{2} 2 H ⌋} {2}^{j} \cdot {σ}_{b}^{( L )} ( j ) - H ) ,$$

$${\hat{y}}_{i} = \frac{1}{2 H} ( {\sum }_{j = 0}^{⌊ lo {g}_{2} 4 H ⌋} {2}^{j} \cdot {σ}_{y} ( i . j ) - 2 H ) , ∀ i ,$$

The value range of the binary variable is:

$${σ}_{w}^{( L )} ( j ) ∈ {\{ 0 , 1 \}}^{m \cdot H} ,$$

$${σ}_{b}^{( L )} ( j ) , {σ}_{y} ( i \cdot j ) ∈ {\{ 0 , 1 \}}^{m} , ∀ i ,$$

The QCBO problem of QNN training can be modeled by using the encoded 01 variable as an optimization variable.

In an embodiment of the present application, the training of the quantized neural network is defined as a quadratic constrained binary optimization problem through the above scheme, and the present application directly uses the inequality constraint in the QCBO problem without introducing auxiliary variables to convert the inequality constraint into the equality constraint, and accordingly, the optimization variables of the QCBO problem may not comprise auxiliary variables, the use of spin numbers is reduced, the bit width of the coefficient matrix is reduced, and the difficulty of subsequent problem solving is reduced at the application level, so that solving by using the Ising machine is easier, and the solution accuracy is higher.

Since the Ising machine is suitable for solving the QUBO problem without any constraint conditions, the QCBO problem can be converted into the QUBO problem, referring back to FIG. 3:

Step S302: convert the quadratic constrained binary optimization problem into a quadratic unconstrained binary optimization problem.

In a possible implementation, the QCBO problem may be converted into a quadratic unconstrained binary optimization (QUBO) problem by using a penalty function method and a Rosenberg reduction method.

The penalty function method is adopted to eliminate all equality constraints to obtain a high-order loss function. The high-order loss function is converted to a quadratic loss function by adopting a Rosenberg reduction method. Finally, a quadratic loss function consisted of binary variables is a QUBO problem, which can be efficiently and quickly solved on an Ising machine. The following describes in detail a manner of converting the QCBO problem into the QUBO problem by using the penalty function method and the Rosenberg reduction method.

Wherein, all equality constraints in the quadratic constrained binary optimization problem can be eliminated by using a penalty function method to construct a high-order loss function; and the penalty function can be reduced by using a Rosenberg order reduction method to convert the quadratic constrained binary optimization problem into a quadratic unconstrained binary optimization problem. The auxiliary variables may comprise r^{(k)}ϵ [symbol] ^{H} and t^{(k)}ϵ [symbol] ^{H} described above.

In the process of eliminating all the equality constraints in the quadratic constrained binary optimization problem by using the penalty function method to construct the high-order loss function, the difference between the two ends of the equality constraints can be obtained, and the square of the difference may be added to the loss function as the penalty term; and the penalty coefficient can be introduced to the penalty term in the loss function to obtain the high-order loss function. The high-order loss function may be a penalty function. The constructed penalty function may be expressed as:

$$\begin{matrix}{ℒ}_{penalty} = \frac{1}{N} {\sum }_{i = 1}^{N} {( {y}_{i} - {\hat{y}}_{i} )}^{2} \\ + ρ {\sum }_{i = 1}^{N} {‖ {W}^{( 1 )} \overline{{x}_{i}} + {b}^{( 1 )} - {s}_{i}^{( 1 )} ‖}^{2} \\ + ρ {\sum }_{i = 1}^{N} {\sum }_{k = 2}^{L - 1} {‖ {W}^{( k )} {a}_{i}^{( k - 1 )} + {b}^{( k )} - {s}_{i}^{( k )} ‖}^{2} \\ + ρ {\sum }_{i = 1}^{N} {‖ {W}^{( L )} {a}_{i}^{( L - 1 )} + {b}^{( L )} - {\hat{y}}_{i} ‖}^{2} \\ + ρ {\sum }_{i = 1}^{N} {\sum }_{k = 1}^{L - 1} {‖ {a}_{i}^{( k )} ⊙ {s}_{i}^{( k )} - {r}_{i}^{( k )} ‖}^{2} \\ + ρ {\sum }_{i = 1}^{N} {‖ {a}_{i}^{( 1 )} + 2 {r}_{i}^{( 1 )} - 1 - {t}_{i}^{( 1 )} ‖}^{2} ,\end{matrix}$$

Where, ρ may represent a penalty coefficient. p may be a large enough positive number, so that a cost of violating the constraint is greater than a cost of improving prediction precision, thereby ensuring satisfaction of the constraint.

In a possible implementation, the reducing the high-order loss function or the augmented Lagrange function by using a Rosenberg order reduction method, and converting the quadratic constrained binary optimization problem into a quadratic unconstrained binary optimization problem comprises: determining a quadratic term factor that appears most frequently in the high-order loss function or the augmented Lagrange function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, converting the quadratic constrained binary optimization problem into a quadratic unconstrained binary optimization problem.

In a process of reducing the penalty function by using a Rosenberg order reduction method, and converting the quadratic constrained binary optimization problem into the quadratic unconstrained binary optimization problem, a quadratic term factor that appears most frequently in the penalty function may be determined, and the quadratic term factor may be replaced with an auxiliary binary variable; the Rosenberg polynomial may be added to an original loss function as a penalty term; and the Rosenberg reduction method may be iteratively performed until the order of the penalty function is reduced to quadratic to obtain a quadratic loss function, and the quadratic constrained binary optimization problem may be converted into a quadratic unconstrained binary optimization problem.
where the Rosenberg polynomial is:

$$h ( {u}_{1} , {u}_{2} , v ) = 3 v + {u}_{1} {u}_{2} - 2 {u}_{1} v - 2 {u}_{2} v$$

where u₁,u₂, v ϵ{10,1}. u₁u₂ may represent a quadratic term factor that appears most frequently in the augmented Lagrange function, and v may represent an auxiliary binary variable.

The Rosenberg polynomial has the following two properties:

$$h ( {u}_{1} , {u}_{2} , v ) \geq 0 , ∀ {u}_{1} , {u}_{2} , v ;$$

h(u₁, u₂, v)=0 if and only if v=u₁u₂

The above properties indicate that when v=u₁u₂=(u₁, u₂, v)=0; when v≠u₁u₂, h(u₁,u₂,v)>0. Therefore, the process of reducing the penalty function by using a Rosenberg order reduction method, and converting the quadratic constrained binary optimization problem into the quadratic unconstrained binary optimization problem may be: in each iteration, it is determined in the penalty function that a product of two variables u₁, u₂ may be replaced with an auxiliary binary variable v, the product is replaced with an auxiliary variable v, then a Rosenberg polynomial h(u₁, u₂, v) consisted of u₁, u₂, v is added to the original loss function as a penalty term, and a sufficiently large positive coefficient is assigned to the penalty term, and the process is iterated until the order of the penalty function is reduced to quadratic.

In a possible implementation, the QCBO problem may be further converted into a quadratic unconstrained binary optimization QUBO problem by using an augmented Lagrange function method and a Rosenberg reduction method.

In the embodiment, step S301 may include:
constructing an augmented Lagrange function based on the quadratic constrained binary optimization problem, reducing the augmented Lagrange function, and converting the quadratic constrained binary optimization problem into a quadratic unconstrained binary optimization problem.

The QCBO problem may be converted into the QUBO problem by an augmented Lagrange function method and a Rosenberg reduction method. The augmented Lagrange function method may be adopted to eliminate all constraints and construct the augmented Lagrange function. The augmented Lagrange function is reduced by adopting the Rosenberg reduction method to obtain a quadratic loss function. The quadratic loss function consisted of binary variables is a QUBO problem, which can be efficiently and quickly solved on an Ising machine.

In the process of constructing an augmented Lagrange function based on the quadratic constrained binary optimization problem, reducing the augmented Lagrange function, and converting the quadratic constrained binary optimization problem into a quadratic unconstrained binary optimization problem, the augmented Lagrange function may be constructed for a loss function and a constraint condition in the quadratic constrained binary optimization problem; and the augmented Lagrange function may be reduced by using a Rosenberg reduction method, and the quadratic constrained binary optimization problem may be converted into the quadratic unconstrained binary optimization problem. The process may be implemented on a CPU.

In the process of constructing the augmented Lagrange function for the loss function and the constraint condition in the quadratic constrained binary optimization problem, the difference between two ends of the equality constraint may be multiplied by the Lagrange multiplier for the equality constraint to obtain the linear penalty term for the equality constraint; the difference between two ends of the inequality constraint may be multiplied by the Lagrange multiplier for the inequality constraint to obtain the linear penalty term for the inequality constraint; the penalty coefficient for the equality constraint may be introduced, and the square of the difference between two ends of the equality constraint may be multiplied by the penalty coefficient for the equality constraint to obtain the quadratic penalty term for the equality constraint; the penalty coefficient for the inequality constraint may be introduced, and the square of the difference between two ends of the inequality constraint may be multiplied by the penalty term for the inequality constraint to obtain the quadratic penalty term for the inequality constraint; and the linear penalty term and the quadratic penalty term for the equality constraint and the inequality constraint may be added to the loss function to obtain the augmented Lagrange function.

The augmented Lagrange function constructed can be expressed as:

$$\text{?} = \frac{1}{N} {\sum }_{i = 1}^{N} {( {y}_{i} - \text{?} )}^{2} + {\sum }_{j}^{\vert ϕ \vert} {λ}_{j} {ϕ}_{j} + {\sum }_{j}^{\vert ϕ \vert} \frac{{ρ}_{1}}{2} {ϕ}_{j}^{2} + {\sum }_{j}^{\vert ψ \vert} {μ}_{j} {ψ}_{j} + {\sum }_{j}^{\vert ψ \vert} \frac{{ρ}_{2}}{2} {ψ}_{j}^{2}$$

$$\text{?} \text{indicates text missing or illegible when filed}$$

where φ represents an equality constraint set, φⱼ represents a difference between two ends of the j-th equality constraint, and

$${\sum }_{j}^{\vert ϕ \vert} {λ}_{j} {ϕ}_{j}$$

represents a linear penalty term for the equality constraint; p represents an inequality constraint set, ψⱼ represents a difference between two ends of the j-th inequality constraint, and

$${\sum }_{j}^{\vert ψ \vert} {μ}_{j} {ψ}_{j}$$

represents a linear penalty term for the inequality constraint; λ₁ represents a Lagrange multiplier of the j-th equality constraint, and μⱼ represents a Lagrange multiplier of the j-th inequality constraint;

$${\sum }_{j}^{\vert ϕ \vert} \frac{{ρ}_{1}}{2} {ϕ}_{j}^{2}$$

represents a quadratic penalty term for the equality constraint,

$${\sum }_{j}^{\vert ψ \vert} \frac{{ρ}_{2}}{2} {ψ}_{j}^{2}$$

represents a quadratic penalty term for the inequality constraint, ρ₁ represents a penalty coefficient for the equality constraint, and ρ₂ represents a penalty coefficient for the inequality constraint.

In the method using the penalty function, the penalty coefficient of the penalty term is generally fixed, and it is very difficult to manually adjust the penalty coefficient when the method using the penalty function processes the constraint condition. Different from the method using the penalty function, in an embodiment using the augmented Lagrange function method, ρ₁ and ρ₂ are fixed hyperparameters, and the Lagrange multipliers μ and λ can be adjusted as required, that is, μ and λ are variable and updated, so that the optimization process is more stable and efficient.

The above-mentioned Rosenberg reduction method comprises: determining a quadratic term factor that appears most frequently in the augmented Lagrange function, and replacing the quadratic term factor with an auxiliary binary variable; adding the Rosenberg polynomial as a penalty term to the original loss function; and iteratively performing the Rosenberg reduction method until an order of the augmented Lagrange function is reduced to quadratic, to obtain a quadratic loss function, and converting the quadratic constrained binary optimization problem into a quadratic unconstrained binary optimization problem. Where the Rosenberg polynomial is:

$$h ( {u}_{1} , {u}_{2} , v ) = 3 v + {u}_{1} {u}_{2} - 2 {u}_{1} v - 2 {u}_{2} v$$

Where, u₁,u₂, v ϵ {0,1}u₁u₂ may represent a quadratic term factor that appears most frequently in the augmented Lagrange function, and V may represent an auxiliary binary variable. In each iteration, it is determined in the augmented Lagrange function that an auxiliary binary variable v may be used to replace a product of two variables u₁, u₂, an auxiliary variable v may be used to replace the product, then a Rosenberg polynomial h (u₁, u₂, v) consisted of u₁, u₂, v is added to the original loss function as a penalty term, and a sufficiently large positive coefficient is assigned to the penalty term, and this process is iterated until the order of the augmented Lagrange function is reduced to quadratic.

Therefore, the QCBO problem can be converted into the QUBO problem.

Step S303, solving the quadratic unconstrained binary optimization problem on the Ising machine to obtain an optimal solution to the quadratic unconstrained binary optimization problem.

The process of solving on the Ising machine can be implemented on a quantum processing unit (QPU), and the process of solving the quadratic unconstrained binary optimization problem on the Ising machine can be expressed as:

$${σ}^{*} = arg {min}_{σ} {L}_{QUBO}$$

In an embodiment using the penalty function method, the loss function L_{QUBO} is obtained by reducing L_{penalty}, and σ* is the optimal solution to the quadratic unconstrained binary optimization problem obtained through optimization performed by Ising machine. In an embodiment using the augmented Lagrange function method, the loss function L_{QUBO} is obtained by reducing L_{lagrange}, σ* is a solution obtained through optimization performed by Ising machine, and the problem can be optimized and solved on the Ising machine in a short time, and generally, the time for solving the QUBO problem on the Ising machine is in milliseconds. The solution result may comprise undecoded, optimized model parameters.

The step S303 may include: updating the coefficients in the augmented Lagrange function based on the solution result, converting to obtain a new quadratic unconstrained binary optimization problem and solving, and obtaining an optimal solution to the quadratic unconstrained binary optimization problem after the constraints are satisfied and the objective function converges.

In the process of updating the coefficients in the augmented Lagrange function based on the solution result, the Lagrange multiplier for the equality constraint and the Lagrange multiplier for the inequality constraint may be updated based on the solution result.

The process of updating the Lagrange multipliers may be implemented on the CPU.

A value of a difference between two ends of the equality constraint and a value of a difference between two ends of the inequality constraint may be determined based on a solution result; a Lagrange multiplier for the equality constraint may be updated to a sum of (i) a product of a difference between two ends of the equality constraint term and a penalty coefficient for the equality constraint, and (ii) an original Lagrange multiplier for the equality constraint; and when a product of a difference between two ends of the inequality constraint term and a penalty coefficient for the inequality constraint is not greater than 0, the Lagrange multiplier for the inequality constraint may be updated to a sum of (i) a product of a difference between two ends of the inequality constraint term and a penalty coefficient for the inequality constraint, and (ii) an original Lagrange multiplier for the inequality constraint, otherwise, the Lagrange multiplier for the inequality constraint is updated to 0.

Since the solution result comprises the values of the model parameters, and the equality constraints and the inequality constraints also comprise the model parameters, the values of the model parameters obtained in the solution result may be substituted into the equality constraints φⱼ and the inequality constraints ψⱼ in the augmented Lagrange function to determine the difference between two ends of each equality constraint and each inequality constraint, for example, the equality constraint set φ and the inequality constraint set ψ may be obtained based on σ*, and the Lagrange multiplier corresponding to each equality constraint and the Lagrange multiplier of the inequality constraint may be updated.

Taking the updating of the Lagrange multiplier corresponding to the j-th equality constraint as an example, the updating method may be expressed as:

$${λ}_{j} ← {λ}_{j} + {ρ}_{1} {ϕ}_{j}$$

The value of λⱼ+ρ₁φⱼ obtained after substituting the solution result may be used as the value of the updated Lagrange multiplier corresponding to the j-th equality constraint, that is, the value of λⱼ in the above augmented Lagrange function may be replaced with the value of λⱼ+ρ₁φⱼ.

Taking the updating of the Lagrange multiplier corresponding to the j-th inequality constraint as an example, the updating method may be expressed as:

$${μ}_{j} ← max ( 0 , {μ}_{j} + {ρ}_{2} {ψ}_{j} )$$

The value of max(0,μⱼ+ρ₂ψⱼ) obtained after substituting the solution result may be used as the value of the updated Lagrange multiplier corresponding to the j-th inequality constraint, that is, the value of μⱼ in the above augmented Lagrange function may be replaced with the value of max(0,μⱼ+ρ₂ψⱼ). By updating and adjusting the Lagrange multiplier through the above process, the Lagrange multiplier does not need to be manually adjusted, so as to solve the QUBO problem on the Ising machine more quickly and accurately.

If there are constraints that are not satisfied or the mean square error objective function does not converge, the next iteration is entered, that is, the subsequent steps are re-executed starting from “reducing the augmented Lagrange function and converting the quadratic constrained binary optimization problem into a quadratic unconstrained binary optimization problem”, until all constraints are satisfied and the mean square error objective function satisfies the convergence condition, which can be arbitrarily selected as needed, for example, the number of iterations reaches a predetermined number.

When the augmented Lagrange function satisfies the convergence condition, the obtained σ* is the optimal solution to the quadratic unconstrained binary optimization problem. Therefore, an optimal solution to the quadratic unconstrained binary optimization problem can be obtained.

Step S304: decode the optimal solution to obtain parameters of the trained multi-layer feedforward neural network.

A decoding result obtained by decoding the optimal solution is an optimal quantized neural network parameter, the optimal quantized neural network parameter is a parameter of the trained multi-layer feedforward neural network, and a decoding process may be expressed as follows:

$${θ}^{*} = decode ( {σ}^{*} )$$

“decode” represents a decoding result obtained by decoding the optimal solution σ*, that is, the optimal quantized neural network parameter θ*. The trained multi-layer feedforward neural network may run on any processor to execute an inference task.

The inference task is, for example, a handwritten digital image recognition problem, which is not limited in the present application. Taking an embodiment of the augmented Lagrange function method as an example, for the image recognition task, in the training stage, based on the image dataset and the set network structure, the supervised learning of the multi-layer feedforward quantized neural network is modeled as a quadratic constrained binary optimization problem on the host, the augmented Lagrange function is constructed based on the quadratic constrained binary optimization problem, the augmented Lagrange function is reduced, and the quadratic constrained binary optimization problem is converted into a quadratic unconstrained binary optimization problem; the host sends the quadratic unconstrained binary optimization problem to be solved to the Ising machine for solving, the Ising machine sends the solution result to the host after solving the quadratic unconstrained binary optimization problem to obtain the solution result, the host updates the coefficients in the augmented Lagrange function based on the solution result, the host converts to obtain a new quadratic unconstrained binary optimization problem and sends the new quadratic unconstrained binary optimization problem to the Ising machine for solving again, the above steps are iterated, after the constraints are satisfied and the objective function converges, the optimal solution to the quadratic unconstrained binary optimization problem can be obtained, the optimal solution is decoded to obtain the parameters of the trained multi-layer feedforward neural network, and the training is completed to obtain the trained multi-layer feedforward neural network.

In the inference stage, the image to be recognized may be input into the trained multi-layer feedforward neural network to output the recognition result corresponding to the image to be recognized.

In the existing Ising machine, the main bottleneck is the number of available spins, and the calculation time is also affected by the number of used spins. The method according to an embodiment of the present application can further reduce the spin number by reducing the number of optimization variables, and reduce the spatial complexity when solving on the Ising machine. According to the embodiments of the present application, the supervised learning of the multi-layer feedforward quantized neural network is modeled as a quadratic constrained binary optimization problem; the quadratic constrained binary optimization problem is converted into a quadratic unconstrained binary optimization problem; the quadratic unconstrained binary optimization problem is solved on an Ising machine to obtain an optimal solution to the quadratic unconstrained binary optimization problem; and the optimal solution is decoded to obtain the parameters of the trained multi-layer feedforward neural network. According to the embodiment, efficient and fast solution can be implemented on the Ising machine to train the multi-layer feedforward neural network, the scheme reduces the use of spin numbers, simplifies the difficulty of problem solution, and can solve large-scale training problems.

For an embodiment using the penalty function method, the present application adds the spin numbers used by all variables to obtain the spatial complexity corresponding to the total spin number used on the Ising machine as:

$$O ( nH + mN log H + HN log n + {H}^{2} L + BHN + mBH + mBN + HLN log H )$$

Spatial complexity means the tendency of spin numbers to increase as training problems become more complex. It can be learned from the foregoing formula that the spatial complexity is related to the network depth L, the network width H, the dataset size N, the dimension n of the input feature, the dimension m of the output feature, and the bit width B of the input feature.

Assuming that n, m, and B is a constant, the spatial complexity becomes O(H²L+HLNlogH) It can be concluded that the spin number is proportional to the dataset size N, proportional to the network depth L, and proportional to the square of the network width H. With the development of time, the number of spin bits of Ising machine will continuously increase, and the technical scheme of the present application has the potential to train deeper networks and larger datasets in the future.

It can be understood that, the multi-layer feedforward neural network training method for the Ising machine provided in the present application finally expresses the supervised learning of the quantized neural network as a quadratic unconstrained binary optimization problem, and solves the quadratic unconstrained binary optimization problem at a high speed on the Ising machine. In addition, as a non-gradient training method, the technical scheme of the present application using a penalty function provides an alternative to the traditional back propagation method, it is the first method of training a multi-layer feedforward network on an Ising machine, unlocking new hardware and new paradigms for neural network training.

To demonstrate the feasibility of embodiments of the present application that utilize penalty functions, embodiments of the present application comprise problem solvability verification, i.e., verifying the solvability of a problem using a simplified version of an MNIST handwritten digital image dataset. The MNIST dataset contains a total of 10 handwritten digital images from 0 to 9, and each image is made up solely of black and white pixels.

In the simplified MNIST handwritten digital image dataset, an embodiment of the present application selects two numbers, i.e., 6 and 9, to construct an image binary classification task. First, the image is preprocessed, the image is divided into four regions, namely, four ranges of upper left, upper right, lower left, and lower right, each region is downsampled into one pixel value, and finally, the entire image is downsampled into an image of 2×2 pixels. In the processed image, each pixel value is −1, 0, or +1, depending on the number of white pixels in the corresponding range in the original image, the downsampled value of the region with the largest number of white pixels is set to +1, the downsampled value of the region with the smallest number of white pixels is set to −1, and the downsampled values of the remaining ranges are set to 0. After preprocessing, only four images, i.e., two images of the number 6 and two images of the number 9, are selected as the training dataset.

For the network structure, a QNN with 1 hidden layer and 1 hidden part was used in the experiment. There are four input parts in the input layer, and each input part receives one pixel value in the 2*2 image. The output value of the last layer is in the range of [−1, +1]. When the output value is non-negative, it means that the prediction is digital 6; when the output value is negative, it means that the prediction is digital 9. As shown in FIG. 5, it shows a schematic diagram of a verification process in the MNIST dataset according to an embodiment of the present disclosure.

Embodiments of the present application utilizing a penalty function method use a GPU-based simulated Ising machine Fixstars Amplify AE for experiments. In the experiment, the original image classification problem is converted into a QUBO problem that can be solved by the Ising machine, and the number of spins used in the converted QUBO problem is 86. In an embodiment of the present application, the annealing time is set to 500 milliseconds, and the probability that the loss function reaches 0 in 100 runs is 88%, which means that the success probability of finding the optimal solution is 88%.

FIG. 6 shows a loss function histogram for optimization training on an MNIST dataset according to an embodiment of the present application.

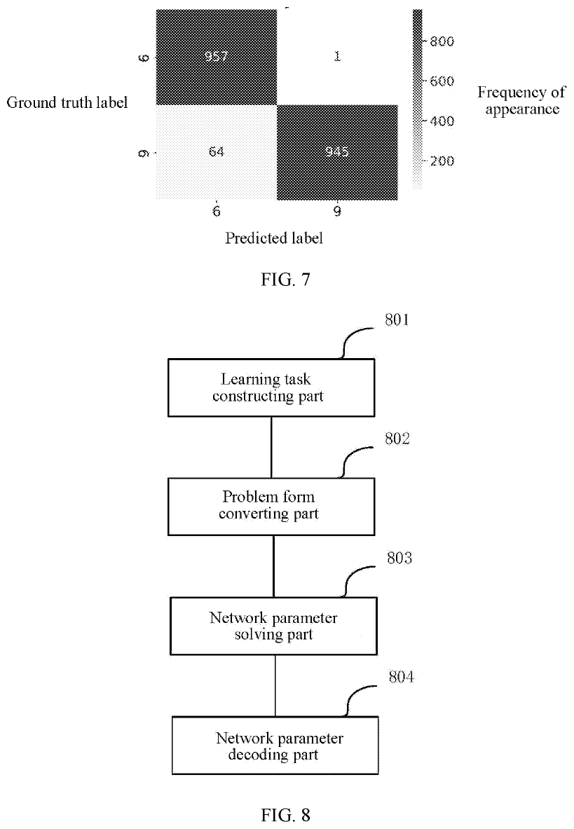

FIG. 7 shows a confusion matrix diagram for image classification verification on an MNIST dataset according to an embodiment of the present application. As shown in FIG. 7, in a test dataset comprising 1967 images, classification accuracy reaches 96.7%. This experimental result successfully demonstrates the solvability of the converted QUBO problem on the Ising machine, and also demonstrates the feasibility of the embodiments of the present application.

However, according to an embodiment of the present application using the augmented Lagrange function method, the augmented Lagrange function is constructed based on the quadratic constrained binary optimization problem, which is different from the method of constructing the penalty function. In the method of the penalty function, it is necessary to convert all the inequality constraints into equality constraints to establish the penalty function, and two types of auxiliary variables need to be introduced when converting the inequality constraints into equality constraints. However, in the embodiments of the present application utilizing the augmented Lagrange function method, it is unnecessary to convert the inequality constraints into the equality constraints, and the augmented Lagrange function can be directly established using the inequality constraints. Since the augmented Lagrange function method is used, it is unnecessary to introduce auxiliary variables in the inequality constraints expression, and the use of the spin numbers can be significantly reduced. Since the main bottleneck in existing Ising machines is the number of available spins, the computation time is also affected by the number of spins used. According to the augmented Lagrange function method and inequality constraint expression of an embodiment using the augmented Lagrange function method of the present application, the time and spatial complexity of solving on the Ising machine can be further reduced compared with the method using the penalty function. The use of spin number is further reduced, the difficulty for problem solving is simplified, solving on the actual device is easier, and large-scale training problems can be addressed.

FIG. 8 shows a structural diagram of a multi-layer feedforward neural network training system for Ising machine according to an embodiment of the present application. As shown in FIG. 8, the device comprises: a learning task constructing part 801 configured to model supervised learning of a multi-layer feedforward quantized neural network as a quadratic constrained binary optimization problem; a problem form converting part 802 configured to convert the quadratic constrained binary optimization problem into a quadratic unconstrained binary optimization problem; a network parameter solving part 803 configured to solve the quadratic unconstrained binary optimization problem on an Ising machine to obtain an optimal solution to the quadratic unconstrained binary optimization problem; and a network parameter decoding part 804 configured to decode the optimal solution to obtain parameters of a trained multi-layer feedforward neural network.

In a possible implementation, the learning task constructing part 801 is configured to: represent an activation function in the feedforward topology of the quantized neural network as an inequality constraint, and represent a linear transformation in the feedforward topology of the quantized neural network as an equality constraint; and model supervised learning of the multi-layer feedforward quantized neural network as a quadratic constrained binary optimization problem based on the loss function of the quantized neural network, the constraint condition, and the encoded optimization variable, where an objective function of the quadratic constrained binary optimization problem is the loss function of the quantized neural network. The constraint conditions comprise equality constraints and inequality constraints.

In a possible implementation, the learning task constructing part 801 is configured to model supervised learning of the multi-layer feedforward quantized neural network as a quadratic constrained binary optimization problem based on a loss function of the quantized neural network, an inequality constraint, an equality constraint, and an encoded optimization variable, an objective function of the quadratic constrained binary optimization problem being the loss function of the quantized neural network, the equality constraint representing a linear transformation in a feedforward topology of the quantized neural network, and the inequality constraint representing an activation function in the feedforward topology of the quantized neural network.

In a possible implementation, the learning task constructing part 801 is configured to: represent an activation function in a feedforward topology of the quantized neural network as an inequality constraint, and represent a linear transformation in the feedforward topology of the quantized neural network as an equality constraint; convert the inequality constraint into the equality constraint by using an auxiliary variable; and model supervised learning of the multi-layer feedforward quantized neural network as a quadratic constrained binary optimization problem based on a loss function of the quantized neural network, the equality constraint, and an encoded optimization variable, where an objective function of the quadratic constrained binary optimization problem is the loss function of the quantized neural network.

In a possible implementation, the optimization variables comprise a quantized weight of each layer in the quantized neural network, a quantization bias of each layer, a value of each layer before activation, a value of each layer after activation, a predicted value of a sample, and an auxiliary variable.

In a possible implementation, the problem form converting part 802 is configured to: convert the inequality constraint into an equality constraint by using an auxiliary variable; eliminate all equality constraints in the quadratic constrained binary optimization problem by using a penalty function method, and construct a high-order loss function, or construct an augmented Lagrange function based on the quadratic constrained binary optimization problem; and reduce the high-order loss function or the augmented Lagrange function by using a Rosenberg order reduction method, and convert the quadratic constrained binary optimization problem into a quadratic unconstrained binary optimization problem. The high-order loss function may be a penalty function.

In a possible implementation, the problem form converting part 802 is configured to: eliminate all equality constraints in the quadratic constrained binary optimization problem by using a penalty function method, and construct a penalty function; and reduce the penalty function by using a Rosenberg order reduction method, and convert the quadratic constrained binary optimization problem into the quadratic unconstrained binary optimization problem.

In a possible implementation, the eliminating all equality constraints in the quadratic constrained binary optimization problem by using a penalty function method to construct a high-order loss function comprises: calculating the difference between the two ends of the equality constraints, and adding a square of the difference to the loss function as a penalty term; and introducing a penalty coefficient to the penalty term in the loss function to obtain the high-order loss function.

In a possible implementation, the reducing the high-order loss function or the augmented Lagrange function by using a Rosenberg order reduction method, and converting the quadratic constrained binary optimization problem into a quadratic unconstrained binary optimization problem comprises: determining a quadratic term factor that appears most frequently in the high-order loss function or the augmented Lagrange function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, converting the quadratic constrained binary optimization problem into a quadratic unconstrained binary optimization problem.

In a possible implementation, the reducing the penalty function by using a Rosenberg order reduction method, and converting the quadratic constrained binary optimization problem into the quadratic unconstrained binary optimization problem, comprises: determining a quadratic term factor that occurs most frequently in the penalty function, and replacing the quadratic term factor with an auxiliary binary variable; adding the Rosenberg polynomial as a penalty term to the original loss function; and iteratively performing the Rosenberg reduction method until the order of the penalty function is reduced to quadratic to obtain a quadratic loss function, and converting the quadratic constrained binary optimization problem into a quadratic unconstrained binary optimization problem.

In a possible implementation, the learning task constructing part 801 is configured to: construct an augmented Lagrange function based on the quadratic constrained binary optimization problem, reduce the augmented Lagrange function, and convert the quadratic constrained binary optimization problem into a quadratic unconstrained binary optimization problem; and the network parameter solving part 803 is configured to: solve the quadratic unconstrained binary optimization problem on an Ising machine, update a coefficient in the augmented Lagrange function based on a solution result, convert to obtain a new quadratic unconstrained binary optimization problem, and solve based on the Ising machine, and obtain an optimal solution to the quadratic unconstrained binary optimization problem after a constraint is satisfied and a loss function converges.

In a possible implementation, the learning task constructing part 801 is configured to model supervised learning of the multi-layer feedforward quantized neural network as a quadratic constrained binary optimization problem based on a loss function of the quantized neural network, an inequality constraint, an equality constraint, and an encoded optimization variable, an objective function of the quadratic constrained binary optimization problem being the loss function of the quantized neural network, the equality constraint representing a linear transformation in a feedforward topology of the quantized neural network, and the inequality constraint representing an activation function in the feedforward topology of the quantized neural network.

In a possible implementation, the optimization variables comprise a quantized weight of each layer in the quantized neural network, a quantization bias of each layer, a value of each layer before activation, a value of each layer after activation, and a predicted value of the sample.

In a possible implementation, the constructing an augmented Lagrange function based on a quadratic constrained binary optimization problem, and reducing the augmented Lagrange function, and converting the quadratic constrained binary optimization problem into a quadratic unconstrained binary optimization problem comprises: constructing the augmented Lagrange function for a loss function and a constraint condition in the quadratic constrained binary optimization problem; and reducing the augmented Lagrange function by using a Rosenberg reduction method, and converting the quadratic constrained binary optimization problem into the quadratic unconstrained binary optimization problem.

In a possible implementation, the reducing the augmented Lagrange function by using a Rosenberg reduction method, and converting the quadratic constrained binary optimization problem into the quadratic unconstrained binary optimization problem comprises: determining a quadratic term factor that appears most frequently in the augmented Lagrange function, and replacing the quadratic term factor with an auxiliary binary variable; adding the Rosenberg polynomial as a penalty term to the original loss function; and iteratively performing the Rosenberg reduction method until an order of the augmented Lagrange function is reduced to quadratic, to obtain a quadratic loss function, and converting the quadratic constrained binary optimization problem into the quadratic unconstrained binary optimization problem.

In a possible implementation, the constructing an augmented Lagrange function for an objective function and a constraint condition in a quadratic constrained binary optimization problem comprises: multiplying a difference between two ends of an equality constraint by a Lagrange multiplier for the equality constraint to obtain a linear penalty term for the equality constraint; multiplying a difference between two ends of an inequality constraint by a Lagrange multiplier for the inequality constraint to obtain a linear penalty term for the inequality constraint; introducing a penalty coefficient for the equality constraint, and multiplying a square of a difference between two ends of the equality constraint by a penalty coefficient for the equality constraint to obtain a quadratic penalty term for the equality constraint; introducing a penalty coefficient for the inequality constraint, and multiplying a square of a difference between two ends of the inequality constraint by a penalty term for the inequality constraint to obtain a quadratic penalty term for the inequality constraint; and adding the linear penalty term and the quadratic penalty term for the equality constraint and the inequality constraint to a loss function to obtain the augmented Lagrange function.

In a possible implementation, the system further comprises a coefficient updating part configured to update the Lagrange multiplier for the equality constraint and the Lagrange multiplier for the inequality constraint based on the solution result.

In a possible implementation, the updating the Lagrange multiplier for the equality constraint and the Lagrange multiplier for the inequality constraint based on the solution result comprises: determining a value of a difference between two ends of the equality constraint and a value of a difference between two ends of the inequality constraint based on the solution result; updating the Lagrange multiplier for the equality constraint to a sum of (i) a product of a difference between two ends of the equality constraint term and a penalty coefficient for the equality constraint, and (ii) an original Lagrange multiplier for the equality constraint; and when the product of the difference between two ends of the inequality constraint term and the penalty coefficient for the inequality constraint is not greater than 0, updating the Lagrange multiplier for the inequality constraint to a sum of (i) a product of the difference between two ends of the inequality constraint term and the penalty coefficient for the inequality constraint, and (ii) an original Lagrange multiplier for the inequality constraint, otherwise, updating the Lagrange multiplier for the inequality constraint to 0.

In a possible implementation, the inequality constraint comprises a same-sign constraint for values of each layer before activation and after activation and a constraint when a boundary condition is satisfied.

In a possible implementation, the encoded optimization variable is obtained by encoding the optimization variable by using a binary representation rule, and the binary representation rule comprises: limiting a variable value range to a specific upper and lower bound range by using a binary representation rule of decimal.

In a possible implementation, the system further comprises: a first weight limiting part, configured to limit linear weights of the multi-layer feedforward quantized neural network except the last layer to +1 or −1; a bias term freezing part, configured to freeze bias terms of the multi-layer feedforward quantized neural network except the first layer and the last layer; and a second weight limiting part, configured to limit the linear weights of the last layer of the multi-layer feedforward quantized neural network and the bias terms of the first layer and the last layer to quantized values with a specific bit width.

According to the embodiments of the present application, the supervised learning of the multi-layer feedforward quantized neural network is modeled as a quadratic constrained binary optimization problem; the quadratic constrained binary optimization problem is converted into a quadratic unconstrained binary optimization problem; the quadratic unconstrained binary optimization problem is solved on an Ising machine to obtain an optimal solution to the quadratic unconstrained binary optimization problem; and the optimal solution is decoded to obtain the parameters of the trained multi-layer feedforward neural network. According to the embodiment, efficient and fast solution can be implemented on the Ising machine to train the multi-layer feedforward neural network, the scheme reduces the use of spin numbers, simplifies the difficulty of problem solution, and can solve large-scale training problems.

According to another aspect of the present application, a multi-layer feedforward neural network training system for an Ising machine is provided. The system comprises: a host, configured to model supervised learning of a multi-layer feedforward quantized neural network as a quadratic constrained binary optimization problem; convert the quadratic constrained binary optimization problem into a quadratic unconstrained binary optimization problem; send the quadratic unconstrained binary optimization problem to be solved to an Ising machine for solving; receive a solution result sent by the Ising machine, and obtain an optimal solution to the quadratic unconstrained binary optimization problem based on the solution result; and decode the optimal solution to obtain parameters of the trained multi-layer feedforward neural network; and the Ising machine, configured to solve the quadratic unconstrained binary optimization problem sent by the host, and send the solution result to the host.

According to another aspect of the present application, an electronic apparatus is provided, comprising: a processor; and a memory for storing processor-executable instructions, wherein the processor is configured to implement the above method when executing the instructions stored in the memory.

According to another aspect of the present application, a computer-readable storage medium is provided, storing computer program instructions, wherein the computer program instructions, when executed by a processor, implementing the above method.

According to another aspect of the present application, a computer program product is provided, comprising computer-readable code or a non-volatile computer-readable storage medium carrying computer-readable code, where when the computer-readable code runs in a processor of an electronic apparatus, the processor in the electronic apparatus executes the foregoing method.

Aspects of the present application are described herein with reference to flowcharts and/or block diagrams of methods, devices (systems) and computer program products according to embodiments of the disclosure. It will be understood that each block of the flowcharts and/or block diagrams, and combinations of blocks in the flowcharts and/or block diagrams, can be implemented by computer readable program instructions.

These computer readable program instructions may be provided to a processor of a general purpose computer, special purpose computer, or other programmable data processing devices to produce a machine, such that the instructions, which execute via the processor of the computer or other programmable data processing devices, create means for implementing the functions/acts specified in one or more blocks in the flowchart and/or block diagram. These computer readable program instructions may also be stored in a computer readable storage medium that can direct a computer, a programmable data processing device, and/or other apparatus to function in a particular manner, such that the computer readable storage medium having instructions stored therein comprises an article of manufacture comprising instructions which implement aspects of the function/act specified in one or more blocks in the flowchart and/or block diagram.

The computer readable program instructions may also be loaded onto a computer, other programmable data processing devices, or other apparatus to cause a series of operational steps to be executed on the computer, other programmable data processing devices or other apparatus to produce a computer implemented process, such that the instructions which execute on the computer, other programmable data processing devices, or other apparatus implement the functions/acts specified in one or more blocks in the flowchart and/or block diagram.

The flowcharts and block diagrams in the accompanying drawings show architectures, functions, and operations that may be implemented by a system, a method, and a computer program product according to a plurality of embodiments of the present application. In this regard, each block in the flowchart or block diagrams may represent a portion, program segment, or portion of instructions, which comprises one or more executable instructions for implementing the specified logical function. In some alternative implementations, the functions noted in the blocks may occur out of the order noted in the figures. For example, two blocks in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, can be implemented by special purpose hardware-based systems that execute the specified functions or acts, or combinations of special purpose hardware and computer instructions.

The embodiments of the present application have been described above, and the above description is exemplary, not exhaustive, and not limited to the disclosed embodiments. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A multi-layer feedforward neural network training method for an Ising machine, comprising:
modeling supervised learning of a multi-layer feedforward quantized neural network as a quadratic constrained binary optimization problem;
converting the quadratic constrained binary optimization problem into a quadratic unconstrained binary optimization problem;
solving a quadratic unconstrained binary optimization problem on the Ising machine to obtain an optimal solution to the quadratic unconstrained binary optimization problem;
decoding the optimal solution to obtain parameters of a trained multi-layer feedforward neural network.

2. The method according to claim 1, wherein the modeling supervised learning of a multi-layer feedforward quantized neural network as a quadratic constrained binary optimization problem comprises:
representing an activation function in a feedforward topology of the quantized neural network as an inequality constraint, and representing a linear transformation in the feedforward topology of the quantized neural network as an equality constraint;
modeling supervised learning of the multi-layer feedforward quantized neural network as a quadratic constrained binary optimization problem based on a loss function of the quantized neural network, a constraint condition, and an encoded optimization variable, wherein an objective function of the quadratic constrained binary optimization problem is the loss function of the quantized neural network.

3. The method according to claim 1, wherein the converting the quadratic constrained binary optimization problem into a quadratic unconstrained binary optimization problem comprises:
converting inequality constraints into equality constraints using auxiliary variables;
eliminating all equality constraints in the quadratic constrained binary optimization problem by using a penalty function method to construct a high-order loss function, or constructing an augmented Lagrange function based on the quadratic constrained binary optimization problem;
reducing the high-order loss function or the augmented Lagrange function by using a Rosenberg order reduction method and converting the quadratic constrained binary optimization problem into the quadratic unconstrained binary optimization problem.

4. The method according to claim 1, wherein the converting the quadratic constrained binary optimization problem into a quadratic unconstrained binary optimization problem comprises:
constructing an augmented Lagrange function based on the quadratic constrained binary optimization problem, reducing an order of the augmented Lagrange function, and converting the quadratic constrained binary optimization problem into the quadratic unconstrained binary optimization problem;
solving the quadratic unconstrained binary optimization problem on the Ising machine to obtain an optimal solution to the quadratic unconstrained binary optimization problem, comprising:
solving the quadratic unconstrained binary optimization problem on the Ising machine, updating coefficients in the augmented Lagrange function based on a solution result, converting to obtain a new quadratic unconstrained binary optimization problem and solving based on the Ising machine, and obtaining the optimal solution to the quadratic unconstrained binary optimization problem after a constraint is satisfied and a loss function converges.

5. The method according to claim 2, wherein the inequality constraint comprises a same-sign constraint for values of each layer before activation and after activation and a constraint based on that a boundary condition is satisfied.

6. The method according to claim 2, wherein the encoded optimization variable is obtained by encoding the optimization variable by using a binary representation rule, and the binary representation rule comprises:
limiting a variable value range to a specific upper and lower bound range by using a binary representation rule of decimal.

7. The method according to claim 2, wherein the optimization variables comprise at least one of: a quantization weight of each layer in the quantized neural network, a quantization bias of each layer, a value of each layer before activation, a value of each layer after activation, a predicted value of a sample, and an auxiliary variable.

8. The method according to claim 1, further comprising:
limiting linear weights of the multi-layer feedforward quantized neural network except a last layer to +1 or −1;
freezing bias terms of the multi-layer feedforward quantized neural network except a first layer and the last layer;
wherein a linear weight of the last layer of the multi-layer feedforward quantized neural network and the bias terms of the first layer and the last layer are limited to quantized values with a specific bit width.

9. A multi-layer feedforward neural network training system for an Ising machine, comprising:
a host configured to model supervised learning of a multi-layer feedforward quantized neural network as a quadratic constrained binary optimization problem; convert the quadratic constrained binary optimization problem into a quadratic unconstrained binary optimization problem; send the quadratic unconstrained binary optimization problem to be solved to an Ising machine for solving; receive a solution result sent by the Ising machine, and obtain an optimal solution to the quadratic unconstrained binary optimization problem based on the solution result; and decode the optimal solution to obtain parameters of the trained multi-layer feedforward neural network;
the Ising machine configured to solve a quadratic unconstrained binary optimization problem sent by the host, and send a solution result to the host.

10. The system according to claim 9, wherein modeling supervised learning of the multi-layer feedforward quantized neural network as a quadratic constrained binary optimization problem comprises:
representing an activation function in a feedforward topology of the quantized neural network as an inequality constraint, and representing a linear transformation in the feedforward topology of the quantized neural network as an equality constraint;
modeling supervised learning of the multi-layer feedforward quantized neural network as a quadratic constrained binary optimization problem based on a loss function of the quantized neural network, a constraint condition, and an encoded optimization variable, wherein an objective function of the quadratic constrained binary optimization problem is the loss function of the quantized neural network.

11. The system according to claim 9, wherein converting the quadratic constrained binary optimization problem into a quadratic unconstrained binary optimization problem comprises:
converting inequality constraints into equality constraints using auxiliary variables;
eliminating all equality constraints in the quadratic constrained binary optimization problem by using a penalty function method to construct a high-order loss function, or constructing an augmented Lagrange function based on the quadratic constrained binary optimization problem;
reducing the high-order loss function or the augmented Lagrange function by using a Rosenberg order reduction method and converting the quadratic constrained binary optimization problem into the quadratic unconstrained binary optimization problem.

12. The system according to claim 9, wherein converting the quadratic constrained binary optimization problem into a quadratic unconstrained binary optimization problem comprises:
constructing an augmented Lagrange function based on the quadratic constrained binary optimization problem, reducing an order of the augmented Lagrange function, and converting the quadratic constrained binary optimization problem into the quadratic unconstrained binary optimization problem;
solving the quadratic unconstrained binary optimization problem on the Ising machine to obtain an optimal solution to the quadratic unconstrained binary optimization problem, comprising:
solving the quadratic unconstrained binary optimization problem on the Ising machine, updating coefficients in the augmented Lagrange function based on a solution result, converting to obtain a new quadratic unconstrained binary optimization problem and solving based on the Ising machine, and obtaining the optimal solution to the quadratic unconstrained binary optimization problem after a constraint is satisfied and a loss function converges.

13. The system according to claim 10, wherein the inequality constraint comprises a same-sign constraint for values of each layer before activation and after activation and a constraint based on that a boundary condition is satisfied.

14. The system according to claim 10, wherein the encoded optimization variable is obtained by encoding the optimization variable by using a binary representation rule, and the binary representation rule comprises:
limiting a variable value range to a specific upper and lower bound range by using a binary representation rule of decimal.

15. The system according to claim 10, wherein the optimization variables comprise at least one of: a quantization weight of each layer in the quantized neural network, a quantization bias of each layer, a value of each layer before activation, a value of each layer after activation, a predicted value of a sample, and an auxiliary variable.

16. The system according to claim 9, further comprising:
limiting linear weights of the multi-layer feedforward quantized neural network except a last layer to +1 or −1;
freezing bias terms of the multi-layer feedforward quantized neural network except a first layer and the last layer;
wherein a linear weight of the last layer of the multi-layer feedforward quantized neural network and the bias terms of the first layer and the last layer are limited to quantized values with a specific bit width.

17. An electronic apparatus, comprising:
a processor;
a memory for storing processor-executable instructions;
wherein the processor is configured to implement a multi-layer feedforward neural network training method for an Ising machine when executing the instructions stored in the memory, the method comprising:
modeling supervised learning of a multi-layer feedforward quantized neural network as a quadratic constrained binary optimization problem;
converting the quadratic constrained binary optimization problem into a quadratic unconstrained binary optimization problem;
solving a quadratic unconstrained binary optimization problem on the Ising machine to obtain an optimal solution to the quadratic unconstrained binary optimization problem;
decoding the optimal solution to obtain parameters of a trained multi-layer feedforward neural network.

18. A computer-readable storage medium, storing computer program instructions, wherein the computer program instructions, when executed by a processor, implement a multi-layer feedforward neural network training method for an Ising machine, the method comprising:
modeling supervised learning of a multi-layer feedforward quantized neural network as a quadratic constrained binary optimization problem;
converting the quadratic constrained binary optimization problem into a quadratic unconstrained binary optimization problem;
solving a quadratic unconstrained binary optimization problem on the Ising machine to obtain an optimal solution to the quadratic unconstrained binary optimization problem;
decoding the optimal solution to obtain parameters of a trained multi-layer feedforward neural network.

19. A computer program product, comprising computer-readable codes or a non-transitory computer-readable storage medium carrying computer-readable codes, wherein when the computer-readable codes run in a processor of an electronic apparatus, the processor in the electronic apparatus executes a multi-layer feedforward neural network training method for an Ising machine, the method comprising:
modeling supervised learning of a multi-layer feedforward quantized neural network as a quadratic constrained binary optimization problem;
converting the quadratic constrained binary optimization problem into a quadratic unconstrained binary optimization problem;
solving a quadratic unconstrained binary optimization problem on the Ising machine to obtain an optimal solution to the quadratic unconstrained binary optimization problem;
decoding the optimal solution to obtain parameters of a trained multi-layer feedforward neural network.
